(19) United States
(12) Patent Application Publication
(10) Pub. No.: US 2023/0312944 A1
(43) Pub. Date: Oct. 5, 2023

(54) UV-CURABLE COATINGS HAVING HIGH REFRACTIVE INDEX

(71) Applicant: BASF SE, Ludwigshafen am Rhein (DE)

(72) Inventors: Nikolay A. GRIGORENKO, Basel (CH); Andre OSWALD, Schweizerhalle (Muttenz) (CH); Gloria RUIZ GOMEZ, Basel (CH)

(21) Appl. No.: 18/021,638

(22) PCT Filed: Aug. 18, 2021
(86) PCT No.: PCT/EP2021/072873

§ 371 Date: Feb. 16, 2023

(30) Foreign Application Priority Data
Aug. 21, 2020 (EP) 20192143.4
Jan. 29, 2021 (EP) 21154371.5

(51) Int. Cl. C09D 7/61; C09D 7/20; C09D 1/00; B05D 1/00; B05D 3/06

(52) U.S. Cl. CPC C09D 7/61; C09D 7/20; C09D 1/00; B05D 1/005; B05D 3/067; B05D 2601/24

(57) ABSTRACT

The present invention relates to coating compositions, comprising i) single or mixed metal oxide nanoparticles, wherein the volume average diameter (Dᵥ50) of the metal oxide nanoparticles is in the range of 1 to 20 nm; the nanoparticles comprise at least one volatile surface-modifying compound selected from alcohols, β-diketones, or salts thereof; carboxylic acids and β-ketoesters and Ge mixtures thereof, wherein the total amount of volatile surface-modifying compounds is at least 5% by weight, preferably at least 10% by weight based on the amount of metal oxide nano-particles, and ii) a solvent, coatings obtained therefrom and the use of the comositions for coating surface relief micro- and nanostructures (e.g. holograms), manufacturing of optical waveguides, solar panels, light outcoupling layers for display and lighting devices and anti-reflection coatings. Coatings obtained from the coating composition have a high refractive index and holograms are bright and visible from any angle, when the coating compositions are applied to them.

The present invention relates to coating compositions, comprising i) single or mixed metal oxide nanoparticles, wherein the volume average diameter (Dᵥ50) of the metal oxide nanoparticles is in the range of 1 to 20 nm; the nanoparticles comprise at least one volatile surface-modifying compound selected from alcohols, β-diketones, or salts thereof; carboxylic acids and β-ketoesters and mixtures thereof, wherein the total amount of volatile surface-modifying compounds is at least 5% by weight, preferably at least 10% by weight based on the amount of metal oxide nanoparticles, and ii) a solvent, coatings obtained therefrom and the use of the compositions for coating surface relief micro- and nanostructures (e.g. holograms), manufacturing of optical waveguides, solar panels, light outcoupling layers for display and lighting devices and anti-reflection coatings. Coatings obtained from the coating composition have a high refractive index and holograms are bright and visible from any angle, when the coating compositions are applied to them.

Metal oxide nanoparticles and their synthesis are, for example, described in R. Deshmukh and M. Niederberger in Chem. Eur. J. 23 (2017) 8542-8570, Robert K. Y. Li et al., Dalton Trans. 42 (2013) 9777, Robert K. Y. Li et al., Nanoscale 4 (2012) 6284-6288, Vitor. S. Amaral et al., RSC Adv., 2014, 4, 46762, Hexing Li et al., CrystEngComm., 2010, 12, 2219, H. Weller et al. J. Amer. Chem. Soc. 125 (2003) 14539, B. Wang et al., Macromolecules 24 (1991) 3449, R. Himmelhuber et al., Optical Materials Express 1 (2011) 252, US2012276683, US2005164876. Surface stabilized titanium dioxide nanoparticle are, for example, described in EP0707051, WO2006094915, US2011226321 and G. J. Ruitencamp et al. J. Nanopart,. Res. 2011, 13, 2779.

For many optical applications, high refractive index materials are highly desirable. However, those materials consist of metal oxides e.g ZrO₂ (RI (Refractive Index) ca. 2.13) or TiO₂ (RI ca. 2.59) which are not easy to process in printing lacquers and are incompatible with organic carrier materials or organic overcoats. A number of methods for compatibilizing e.g. TiO₂-surfaces have been described (D. Geldof et al. Surface Science, 2017, 655, 31).

WO2019016136 relates to surface functionalized titanium dioxide nanoparticles, a method for their production, a coating composition, comprising the surface functionalized titanium dioxide nanoparticles and the use of the coating composition for coating holograms, wave guides and solar panels. Holograms are bright and visible from any angle, when printed with the coating composition, comprising the surface functionalized titanium dioxide nanoparticles.

S. Zhang et al., Chemical Engineering Journal 371 (2019) 609 describe the preparation of TiO₂ organic nanocomposite coatings with high transmittance and durable superhydrophilicity via the homogeneous compositing of modified anatase TiO₂ nanoparticles (NPs) and hydroxyethyl acrylate (HEA) without any solvent.

EP0969934A1 describes a method of applying a hydrophobic film to a surface, the method comprising the steps of:
(a) optionally modifying particles, such as, for example, silica, or titanium dioxide particles, to be coated on the surface so as to form functional groups thereon;
(b) applying particles having functional groups thereon to the surface to be coated: and
(c) treating the applied particles such that the particles are bound together and to the surface by chemical crosslinking of the functional groups on the particles to form thereby a hydrophobic film wherein the functional groups are crosslinked.

EP1305374A1 discloses dual cure coating compositions having improved scratch resistance, coated substrates and methods related thereto. The coating composition are formed from components comprising:
(a) at least one first material comprising at least one radiation curable reactive functional group;
(b) at least one second material comprising at least one thermally curable reactive functional group;
(c) at least one curing agent reactive with the at least one thermally curable reactive functional group, the at least one curing agent being selected from aminoplast resins, polyisocyanates, blocked polyisocyanates, triazine derived isocyanates, polyepoxides, polyacids, polyols and mixtures of the foregoing; and
(d) a plurality of particles selected from inorganic particles, composite particles, and mixtures of the foregoing, wherein each component is different.

EP1838775A2 relates to durable high index nanocomposites for antireflective coatings and discloses a UV-curable optical coating comprising: a polymerizable monomer/oligomer mixture; and surface modified inorganic nanoparticles comprising surface modified zirconia nanoparticles, wherein said surface-modified nanoparticles comprise a majority of greater than 50% by weight of the nanoparticles having an average crosssectional diameter of 10-30 nanometers and a minority of 10 to 33% by weight of the nanoparticles having an average cross-sectional diameter of 80-150 nanometers, wherein said optical coating has a refractive index of at least 1.6, wherein said coating has a 10 point mean roughness value of at least 30 nanometers.

WO2006/073856A3 relates to UV curable optical coatings comprising: a polymerizable monomer/oligomer mixture; and surface modified inorganic nanoparticles comprising surface modified zirconia nanoparticles, wherein said optical coating has a refractive index of at least 1.6, wherein said coating has a 10 point mean roughness value of at least 30 nanometers.

EP2752392A1 describes an inorganic oxide transparent dispersion comprising: inorganic oxide particles, especially zirconia particles, which are modified using a surface modifier, especially silan coupling agents, and have an average dispersed particle diameter in a range of 1 nm to 50 nm; a high-polarity solvent which dissolves resins and does not easily erode curable resins obtained by curing the resins; and a basic substance, wherein the high-polarity solvent is any one or two of alcohols and ethers.

C. Becker-Willinger et al. (Proceedings of SPIE (2010), 7590(Micromachining and Mk crofabrication Process Technology XV), 759001/1-759001/11) reports on kinetic investigations on TiO₂ nanoparticles as photoinitiators for UV-polymerization in acrylic matrix. TiO₂ nanoparticles of anatase, useful as photosensitive initiators to induce free radical polymerization in acrylic monomers have been prepared by chemical synthesis. Appropriate surface modification of TiO₂ was achieved to compatibilize the particles with the acrylic monomers to obtain an almost homogeneous distribution down to the primary particle size. In this direction, particles have been synthesized in-situ and ex-situ with the acrylic matrix using different precursors and surface modifiers. Ex-situ produced particles had to be dispersed finally into the acrylate monomer mixt. Residual solvent has been removed by distillation. The formation of the anatase modification could be shown by XRD. Particle sizes were detected by PCS, which showed a distribution between 1-10 nm depending on the used prepn. method.

TW201213240A describes high refractive index TiO₂ nano-composite optical film and production process thereof. Firstly, sol-gel process via hydrolysis and condensation reaction was employed for preparation of nano-scale titanium oxide particles. Then methacrylic acid, alkyloxysilyl compound etc. were grafted on the particle surface for improving compatibility, raising solid content, decreasing surface roughness, hindering particle growth in the organic resin structure, thus ensuring a stable and operative hybrid sol was obtained. To improve structure, mechanical property and hardness of titanium oxide hybrid optical film, acrylic monomer crosslinking in conjunction with UV cure were conducted on the plastic substrate. The produced film can exhibit the properties of refractive index of 1.75, colorless in visible region, good adherence to substrate and lower than 3.2 nm of surface roughness, thus has potential for application to anti-reflection coating of optical devices.

U.S. Pat. No. 8,354,160B2 discloses an article comprising: a substrate having a micropatterned surface comprising raised portions, recessed portions or a combination thereof; and a hydrophobic coating composition on the substrate located at least on the portions between the raised portions or in the recessed portions and comprising: a cross-linked fluoropolymer binder selected from the group consisting of poly-1,1-difluoroethylene; copolymers of 1,1-difluoroethylene and hexafluoropropylene, copolymers of tetrafluoroethylene and hexafluoropropylene; copolymers of 1,1-difluoroethylene and tetrafluoroethylene; terpolymers of hexafluoropropylene, tetrafluoroethylene, and ethylene; and terpolymers of tetrafluoroethylene, hexafluoro-propylene and 1,1-difluoroethylene and hydrophobic microparticles, hydrophobic nanoparticles, or a mixture thereof; in sufficient quantity to provide a very hydrophobic or superhydrophobic surface, the particle size of said hydrophobic particles being smaller than the center-to-center distance between the raised or recessed portions of the micropatterned surface.

DE102008010663A1 relates to nanoscale particles of titanium oxide with strongly reduced or suppressed photocatalytic activity, characterized in that they
(a) contain one or more alkali and/or alkaline earth metal ions include at least one;
(b) have an average particle size of less than 20 nm; and
(c) are redispersible to primary particle size; and a composition comprising nanoscale particles of titanium oxide and a matrix forming material (inorganic or organically modified inorganic matrix-forming material).

The titanium dioxide particles of DE102008010663A1 are prepared by a method comprising the steps of: (a) preparing a mixture comprising at least one hydrolyzable titanium compound, an organic solvent, an acidic condensation catalyst and at least one alkali metal compound and/or and/or alkaline earth metal compound; (b) adding water in a less than stoichiometric amount, based on the hydrolyzable groups of the titanium compound; (C) treating the resulting mixture at a temperature of 60° C. to form a dispersion, or precipitate of titanium dioxide particles; (d) removal of the solvent to form a powder of titanium dioxide particles.

US20090209665A1 relates to a stable colloidal titanium dioxide sol comprising titanium dioxide particles dispersed in an aqueous solution comprising an organic peptizing agent which is a mono-, di- or trialkyl amine base, said titanium dioxide particles being amorphous and having an average particle size of less than about 50 nm, in particular less than 10 nm; wherein the sol is transparent and stable for at least 1 month at room temperature. The stable, transparent colloidal titanium dioxide sol of US20090209665A1 is prepared by a method, comprising:
(i) obtaining a solution of a titanium dioxide precursor compound;
(ii) hydrolyzing the titanium dioxide precursor compound to form titanium dioxide, wherein the titanium dioxide precipitates from the solution as amorphous titanium dioxide particles having an average particle size of less than 50 nm;
(iii) isolating the amorphous titanium dioxide particles from step (ii);
(iv) forming a dispersion of the amorphous titanium particles of step (iii) in a liquid medium; and (v) treating the dispersion of step (iv) with an organic peptizing agent to form a stable, transparent or translucent sol comprising amorphous titanium dioxide particles, wherein the peptizing agent is a mono-, di- or trialkylamine. The organic peptizing agent used in the method may also be a carboxylic acid.

WO2006/048030 relates to a process for the production of titanium-containing oxide particles having an average primary particle size of 25 nm or less, which comprises the reaction of a hydrolysable halide-containing titanium compound with water in a reaction mixture comprising a polyol. With the titanium-containing oxide particles of WO2006/048030 aqueous dispersions having solid contents up to about 70 wt % can be prepared.

Coatings with high refractive index are of interest for many optical applications. Such coatings may be based on composite organic-inorganic materials, comprising metal oxide nanoparticles and organic matrix. Most of the applications require the high refractive index coatings to be crosslinkable, either via thermal or actinic radiation curing mechanisms.

One of the possible approaches to achieve that consists in preparing a composition, comprising metal oxide nanoparticles, polymerizable monomer(s), such as acrylate(s) or methacrylate(s), and a radical photoinitiator, coating the composition onto the target substrate and polymerizing by means of UV-light irradiation.

However, achieving highly crosslinked coatings requires a relatively high ratio of organic monomers and photoinitiator to metal oxide nanoparticles, which leads to the pronounced reduction of the refractive index of the coating, compared to pure metal oxide nanoparticles. In addition, radical curing in thin layers under ambient atmosphere may be troublesome due to the inhibition of polymerization reaction by oxygen.

It is the object of present invention to provide compositions, suitable for manufacturing crosslinkable coatings with high refractive index and relatively low thickness in the absence of photoinitiator and polymerizable monomers.

For example, the dispersions of TiO₂ nanoparticles, synthesiszed according to example 1A of WO2021/052907, may be coated onto a substrate without a binder and crosslinked by irradiation with UV-light. Such cross-linking method improves mechanical stability and chemical resistance of the high refractive index coating.

A “cross-linked coating” means a three-dimensional network of metal oxide particles connected to each other via oxygen bonds.

Accordingly, the present invention relates to coating composition, comprising
i) single or mixed metal oxide nanoparticles, wherein the volume average diameter (Dᵥ50) of the metal oxide nanoparticles is in the range of 1 to 20 nm; the nanoparticles comprise at least one volatile surface-modifying compound selected from alcohols, β-diketones, or salts thereof; carboxylic acids and β-ketoesters and mixtures thereof, wherein the total amount of volatile surface-modifying compounds is at least 5% by weight, preferably at least 10% by weight based on the amount of metal oxide nanoparticles, and
ii) a solvent.

Preferably, the composition comprises:
i) 1 to 40% by weight of metal oxide nanoparticles, comprising the volatile surface-modifying compounds; and
ii) 60 to 99% by weight of solvent, based on the total weight of components i) and ii).

More preferably, the composition comprises:
i) 2 to 20% by weight of metal oxide nanoparticles, comprising the volatile surface-modifying compounds; and
ii) 80 to 98% by weight of solvent, based on the total weight of components i) and ii).

Most preferably, the composition comprises:
i) 3 to 10% by weight of metal oxide nanoparticles, comprising the volatile surface-modifying compounds; and
ii) 90 to 97% by weight of solvent, based on the total weight of components i) and ii).

The composition may further comprise a thickener (rheology modifier), a defoamer and/or levelling agent in a total amount up to 20% by weight, preferably up to 10% by weight based on the amount of metal oxide nanoparticles, comprising the volatile surface-modifying compounds.

Accordingly, the composition may consist of:
i) 3 to 10% by weight of metal oxide nanoparticles, comprising the volatile surface-modifying compounds;
ii) 90 to 97% by weight of solvent, based on the total weight of components i) and ii); and
iii) a thickener (rheology modifier), a defoamer and/or levelling agent in a total amount up to 20% % by weight, preferably up to 10% % by weight based on the amount of component i).

Preferably, the coating composition comprises less than 1% w/w of water.

Preferably, the coating composition does not comprise an organic radical photoinitiator.

The pH of the coating composition is in the range of 3 to 10, preferably 3 to 7.

Preferably, the coating composition does not comprise a binder.

Preferably, the coating composition does not comprise titanium oxide nanoparticles containing one or more alkali and/or alkaline earth metal ions which are characterized by having strongly reduced or suppressed photocatalytic activity.

Preferably, the metal oxide nanoparticles are titanium dioxide nanoparticles, which are preferably present in the anatase modification. The photoactivity of the anastase modification facilitates the crosslinking of the titanium dioxide nanoparticles.

The volatile surface-modifying compound is selected from alcohols, β-diketones, or salts thereof; carboxylic acids, such as, for example, such as formic acid, acetic acid, propionic acid and acrylic acid; and β-ketoesters, such as ethyl acetoacetate and ethyl trifluoroacetoacetate, and β-ketoesters and mixtures thereof. The alcohols are especially C₁-C₄alcohols, such as, for example, ethanol, 1-propanol and isopropanol.

Preferably, the volatile surface-modifying compound is selected from C₁-C₄alcohols, such as, for example, ethanol, 1-propanol and isopropanol; β-diketones and mixtures thereof. More preferably, the volatile surface-modifying compound is selected from ethanol and acetylacetone and mixtures thereof.

Preferably, the volatile surface-modifying compound comprises at least a C₁-C₄alcohol, such as, for example, ethanol, 1-propanol and isopropanol; and optionally at least one β-diketone, especially ethanol and acetylacetone.

Preferably, the total amount of volatile surface-modifying compounds is at least at least 15% by weight, preferably at least 20% by weight, more preferably at least 25% by weight based on the amount of metal oxide nanoparticles. Preferably, the total amount of volatile surface-modifying compounds is less than 50% by weight, especially less than 40% by weight, very especially less than 35% by weight based on the amount of metal oxide nanoparticles. The total amount of volatile surface-modifying compounds is in the range of from 15 to 50% by weight, especially from 20 to 40% by weight, very especially from 25 to 35% by weight based on the amount of metal oxide nanoparticles.

The total amount of volatile surface-modifying compounds is determined by thermogravimetric analysis (weight loss in the range from 200 to 600° C. relative to the residue at 600° C., with the proviso that the highest boling solvent in the composition has a boiling point below about 170° C.).

Preferably, the volume average diameter (Dᵥ50) of the metal oxide nanoparticles, especially titanium dioxide nanoparticles, is in the range of 1 to 10 nm, preferably 1 to 5 nm.

Preferably, the solvent is selected from C₂-C₄alcohols, especially ethanol, 1-propanol and isopropanol; ketones, especially acetone, 2-butanone, 2-pentanone, 3-pentanone, cyclopentanone and cyclohexanone; ether alcohols, especially 1-methoxy-2-propanol; mixtures thereof and their mixtures with esters, especially ethyl acetate, 1-propyl acetate, isopropyl acetate and butyl acetate. Mixtures with esters are less preferred. Ethanol, 1-propanol, isopropanol, acetone, 2-butanone, cyclopentanone and mixtures thereof are preferred. Ethanol, 2-butanone, cyclopentanone and mixtures thereof are most preferred.

A process for the preparation of the composition of single, or mixed metal oxide nanoparticles may comprise the following steps:
a) preparing a mixture, comprising a metal oxide precursor compound(s), a solvent, a tertiary alcohol, or a secondary alcohol, wherein the tertiary alcohol and secondary alcohol eliminate water upon heating the mixture to a temperature of above 60° C., or mixtures, containing the tertiary alcohol(s) and/or the secondary alcohol(s), and optionally water,
b1) heating the mixture to a temperature of above 60° C., especially to a temperature of from 80 to 180° C.;
b2) separating the obtained metal oxide nanoparticles from the mixture;
b3) resuspending the metal oxide nanoparticles in an alcohol, or a mixture of alcohols;
b4) optionally treating the metal oxide nanoparticles with a volatile surface-modifying compound selected from p-diketones, carboxylic acids and p-ketoesters and mixtures thereof; or salts thereof, which are preferably selected from compounds of formula Me(OR²⁰)ₓ(L)_{y} (V), or mixtures thereof, wherein R²⁰ is a C₁-C₈ alkyl group, preferably, a C₁-C₄ alkyl group, such as, for example, methyl, ethyl, n-propyl, iso-propyl and n-butyl;

L⁻ is a group of formula

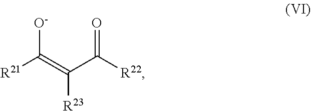

R²¹ and R²² are independently of each other a C₁-C₈alkyl group; a phenyl group, which may optionally be substituted by one or more C₁-C₄alkyl groups, or C₁-C₄alkoxy groups; a C₂-C₅heteroaryl group, which may optionally be substituted by one or more C₁-C₄alkyl groups, or C₁-C₄alkoxy groups; or a C₁-C₈alkoxy group,

R²³ is a hydrogen atom, a fluorine atom, a chlorine atom, or a C₁-C₈alkyl group, or

R²¹ and R²² together form a cyclic or bicyclic ring, which may optionally be substituted by one or more C₁-C₄alkyl groups;

Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V), preferably Zn (II), Ti (IV), Zr (IV), Hf (IV), Sn (IV), Nb (V) and Ta (V), more preferably Ti (IV), Zr (IV), Sn (IV), Nb (V) and Ta (V),

x is in the range from 0 to 4.9, preferably 0 to 4.5, y is in the range from 0.1 to 5, preferably 0.5 to 5, and the sum x+y equals to the oxidation state of metal;
c1) treating the metal oxide nanoparticles with a base, especially a base which is selected from the group consisting of alkali metal alkoxides, alkali metal hydroxides, alkali metal salts of carboxylic acids, tetraalkylammonium hydroxides, trialkylbenzylammonium hydroxides and combinations thereof,
c2) optionally treating the metal oxide nanoparticles with the volatile surface-modifying compound, or salts thereof; and
c3) optionally treating the TiO₂ nanoparticles with a compound of formula Me′(OR^{20′})_{z} (VII), or mixtures thereof, wherein
   R^{20′} is a C₁-C₈alkyl group, preferably a C₁-C₄ alkyl group;

Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V), preferably Ti (IV), Zr (IV), Sn (IV), Nb (V) and Ta (V); and

z equals to the oxidation state of metal; wherein

the metal oxide precursor compound(s) is selected from the group consisting of metal alkoxides of formula Me(OR¹²)ₓ (I), metal halides of formula Me′(Hal)_{x′} (II) and metal alkoxyhalides of formula Me″(Hal′)ₘ(OR^{12′})ₙ (III) and mixtures thereof, wherein Me, Me′ and Me″ are independently of each other titanium, tin, tantalum, niobium, hafnium, or zirconium;

x represents the valence of the metal and is either 4 or 5,

x′ represents the valence of the metal and is either 4 or 5;

R¹² and R^{12′} are independently of each other a C₁-C₈alkyl group;

Hal and Hal′ are independently of each other Cl, Br or I;

m is an integer of 1 to 4;

n is an integer of 1 to 4;

m+n represents the valence of the metal and is either 4 or 5; the solvent comprises at least one ether group and is different from the tertiary alcohol and the secondary alcohol;

the ratio of the sum of moles of hydroxy groups of tertiary alcohol(s) and secondary alcohol(s) to total moles of Me, Me′ and Me″ is in the range 1:2 to 6:1.

The total amount of volatile surface-modifying compounds is at least 5% by weight, preferably at least 10% by weight based on the amount of metal oxide nanoparticles.

The tertiary alcohol is preferably a compound of formula (IVa).

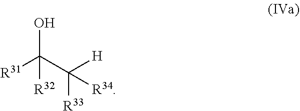

R³¹ and R³² are independently from each other a C₁-C₈alkyl group, a C₃-C₇cycloalkyl group, a C₂-C₈alkenyl group, a C₅-C₇cycloalkenyl group, or a C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups, with the proviso that a hydroxy group is not attached to the aromatic ring. R³³ and R³⁴ are independently from each other H; a C₁-C₈alkyl group, a C₅-C₇cycloalkyl group, a C₂-C₈alkenyl group, a C₅-C₇cycloalkenyl group, or a C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl group, hydroxyC₁-C₈alkyl, hydroxyC₅-C₇cycloalkyl, or C₁-C₈alkoxy groups; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups.

Alternatively, R³¹ and R³², or R³¹ and R³³, or R³³ and R³⁴ may form a 4 to 8 membered ring, optionally containing 1 or 2 carbon-carbon double bonds and/or 1 or 2 oxygen atoms. The 4 to 8 membered ring may further be substituted with one, or more C₁-C₈alkyl, C₅-C₇cycloalkyl, C₂-C₈alkenyl, C₅-C₈aryl, C₅-C₇cycloalkenyl, hydroxyC₁-C₈alkyl, hydroxyC₅-C₇cycloalkyl, or C₁-C₈alkoxy groups; a methylene group, optionally substituted with C₁-C₈alkyl, or C₅-C₇cycloalkyl groups.

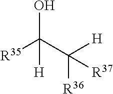

The secondary alcohol is preferably a compound of formula (IVb).

R³⁵ is a vinyl group, optionally substituted with one, or more C₁-C₈alkyl, C₅-C₇cycloalkyl, C₂-C₈alkenyl, C₅-C₇cycloalkenyl, or C₂-C₈alkynyl groups, optionally substituted with one, or more hydroxy, or C₁-C₈alkoxy groups.

an allyl group, optionally substituted with one, or more hydroxy, C₁-C₈alkyl, C₅-C₇cycloalkyl, C₂-C₈alkenyl, C₅-C₇cycloalkenyl, C₅-C₈aryl, or C₂-C₈alkynyl groups, which may further be substituted with hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; a benzyl group optionally substituted with one, or more hydroxy, C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; with the proviso that hydroxy group is not attached to the aromatic ring.

R³⁶ and R³⁷ are independently from each other H; C₁-C₈alkyl group, a C₅-C₇cycloalkyl group, an C₂-C₈alkenyl group, a C₅-C₇cycloalkenyl group, or an C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups, with the proviso that hydroxy group is not attached to the aromatic ring.

Alternatively, R³⁵ and R³⁶, or R³⁶ and R³⁷ may form a 4 to 8 membered ring, optionally containing 1 or 2 carbon-carbon double bonds and/or 1 or 2 oxygen atoms. The 4 to 8 membered ring may further be substituted with one, or more C₁-C₈alkyl, C₅-C₇cycloalkyl, C₂-C₈alkenyl, C₅-C₈aryl, C₅-C₇cycloalkenyl, hydroxyC₁-C₈alkyl, hydroxyC₅-C₇cycloalkyl, or C₁-C₈alkoxy groups; a methylene group, optionally substituted with C₁-C₈alkyl, or C₅-C₇cycloalkyl groups.

Neither of R³¹, R³², R³³, R³⁴, R³⁵, R³⁶ and R³⁷ contain vinyloxy

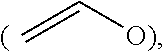

or ethynyloxy

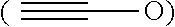

fragments.

The secondary alcohol is more preferably a compound of formula

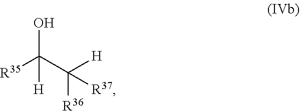

wherein R³⁵ is a vinyl group, optionally substituted with one, or more C₁-C₈alkyl groups; a phenyl group, optionally substituted with one, or more C₁-C₈alkyl, or C₁-C₈alkoxy groups; R³⁶ and R³⁷ are independently from each other H; C₁-C₈alkyl group, optionally substituted with one, or more hydroxy, or C₁-C₈alkoxy groups; a phenyl group, optionally substituted with one, or more C₁-C₈alkyl, or C₁-C₈alkoxy groups; or
R³⁵ and R³⁶, or R³⁶ and R³⁷ may form a 5, or 6 membered ring, optionally containing a carbon-carbon double bond and/or optionally substituted with one, or more C₁-C₈alkyl groups.

The secondary alcohol of formula (IVb) used in step a) is even more preferably selected from the group consisting of 1-phenylethanol, 1-phenylpropanol, 1-phenyl-1-butanol, 1-butene-3-ol, 1-pentene-3-ol, 2-cyclohexen-1-ol, 3-methyl-2-cyclohexen-1-ol.

Tertiary alcohols of formula (IVa) are more preferred than secondary alcohols of formula (IVb).

The tertiary alcohol is more preferably a tertiary alcohol of formula (IVa), wherein R³¹ is a C₁-C₈alkyl group,

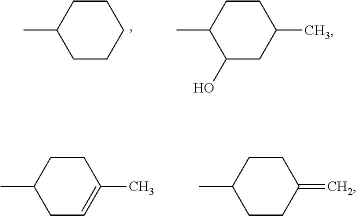

a benzyl group, a phenyl group, which is optionally substituted with one, or more C₁-C₄alkyl and/or C₁-C₄alkoxy groups; or a vinyl group, which is optionally substituted with one, or more C₁-C₄alkyl groups; R³², R³³ and R³⁴ are independently of each other a C₁-C₈alkyl group, which is optionally substituted by a hydroxy group, or a C₁-C₈alkenyl group, which is optionally substituted by a hydroxy group; or

R³¹ and R³² together with the carbon atom to which they are bonded form a 5, or 6 membered ring, optionally containing a carbon-carbon double bond and/or optionally substituted with one, or more C₁-C₈alkyl groups, or a methylene group, optionally substituted with one, or two C₁-C₈alkyl groups, especially R³¹ and R³² together with the carbon atom to which they are bonded form a ring

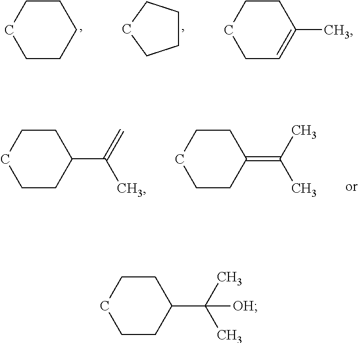

or

R³³ and R³⁴ may form a 5, or 6 membered ring, optionally containing a carbon-carbon double bond and/or optionally substituted with one, or more C₁-C₈alkyl groups.

The tertiary alcohol used in step a) is preferably selected from the group consisting of tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 1-vinylcyclohexanol, 2-methyl-2,4-pentanediol, 2,4-dimethyl-2,4-pentanediol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 1-methoxy-2-methyl-2-propanol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), 3,7-dimethylocta-1,5-dien-3,7-diol (terpenediol 1), terpinen-4-ol (4-carvomenthenol), (±)-3,7-dimethyl-1,6-octadien-3-ol (linalool) and mixtures thereof.

More preferred tertiary alcohols of formula (IV) are selected from tert-butanol, 2-methyl-2-butanol (tert-pentanol), 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol).

The at present most preferred tertiary alcohols of formula (IVa) are 2-methyl-2-butanol and 2,5-dimethyl-2,5-hexanediol.

C₁-C₈alkyl is typically linear or branched, where possible. Examples are methyl, ethyl, n-propyl, isopropyl, n-butyl, sec.-butyl, isobutyl, tert-butyl, n-pentyl, 2-pentyl, 3-pentyl, 2,2-dimethyl-propyl, n-hexyl, n-heptyl, n-octyl, 1,1,3,3-tetramethylbutyl and 2-ethylhexyl. C₁-C₄alkyl is typically methyl, ethyl, n-propyl, isopropyl, n-butyl, sec.-butyl, isobutyl, tert-butyl.

Examples of linear or branched C₁-C₈alkoxy are methoxy, ethoxy, n-propoxy, isopropoxy, n-butoxy, sec.-butoxy, isobutoxy, tert.-butoxy, n-pentyloxy, 2-pentyloxy, 3-pentyloxy, 2,2-dimethylpropoxy, n-hexyloxy, n-heptyloxy, n-octyloxy, 1,1,3,3-tetramethylbutoxy and 2-ethylhexyloxy, preferably C₁-C₄alkoxy such as typically methoxy, ethoxy, n-propoxy, isopropoxy, n-butoxy, sec.-butoxy, isobutoxy, tert-butoxy.

Examples of C₂-C₈alkenyl groups are straight-chain or branched alkenyl groups, such as, for example, vinyl, allyl, methallyl, isopropenyl, 2-butenyl, 3-butenyl, isobutenyl, npenta-2,4-dienyl, 3-methyl-but-2-enyl, n-oct-2-enyl.

C₂-C₈alkynyl is straight-chain or branched and is, for example, ethynyl, 1-propyn-3-yl, 1-butyn-4-yl, 1-pentyn-5-yl, 2-methyl-3-butyn-2-yl, 1,4-pentadiyn-3-yl, 1,3-pentadiyn-5-yl, 1-hexyn-6-yl, cis-3-methyl-2-penten-4-yn-1-yl, trans-3-methyl-2-penten-4-yn-1-yl, 1,3-hexadiyn-5-yl, 1-octyn-8-yl.

Examples of a C₅-C₇cycloalkyl group are cyclopentyl, cyclohexyl and cycloheptyl, optionally substituted with one, or more C₁-C₈alkyl groups, or a methylene group, optionally substituted with one, or two C₁-C₈alkyl groups.

The C₅-C₇cycloalkenyl is a C₅-C₇cycloalkyl group, containing one, or two carbon carbon double bonds.

The solvent used in step a) is preferably selected from the group consisting of tetrahydrofuran, 2-methyltetrahydrofurane, tetrahydropyrane, 1,4-dioxane, cyclopentylmethyl ether, diisopropyl ether, di-n-propyl ether, di-isobutyl ether, di-tert-butyl ether, di-n-butyl ether, di(3-methylbutyl) ether (diisoamyl ether), di-n-pentyl ether, di-n-hexyl ether, di-noctyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, 1,2-dimethoxypropane, 1,2-diethoxypropane, 1,3-dimethoxypropane, 1,3-diethoxypropane, 1,4-dimethoxybutane, 1,4-diethoxybutane, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof.

More preferred, the solvent is selected from 2-methyltetrahydrofurane, tetrahydropyrane, 1,4-dioxane, cyclopentylmethyl ether, di-n-propyl ether, di-isobutyl ether, di-tertbutyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof.

The metal oxide precursor compound(s) is selected from the group consisting of metal alkoxides of formula Me(OR¹²)ₓ (I),

metal halides of formula Me′(Hal)_{x′} (II) and

metal alkoxyhalides of formula Me″(Hal′)ₘ(OR^{12′})ₙ (III) and mixtures thereof.

Me, Me′ and Me″ are independently of each other titanium, tin, tantalum, niobium, hafnium, or zirconium, especially titanium.

x represents the valence of the metal and is either 4 or 5.

x′ represents the valence of the metal and is either 4 or 5.

R¹² and R^{12′} are independently of each other a C₁-C₈alkyl group; especially a C₁-C₄alkyl group.

Hal and Hal′ are independently of each other Cl, Br or I; especially Cl.

m is an integer of 1 to 4.

n is an integer of 1 to 4.

m+n represents the valence of the metal and is either 4 or 5;

Preferably, the mixture used in step a) comprises a metal alkoxide of formula (I) and a metal halide of formula (II).

The metal alkoxide of formula (I) is preferably a metal alkoxide of formula Me(OR¹²)₄ (Ia), wherein R¹² is a C₁-C₄alkyl group. The metal halide of formula Me′(Hal)_{x′} (II) is preferably a metal halide of formula Me′(Hal)₄ (II), wherein Hal is Cl. Me and Me′ are preferably titanium.

The ratio of moles of hydroxy groups of tertiary alcohol to total moles of Ti is in the range 1:2 to 6:1, preferably 1:2 to 4:1, most preferably 1:2 to 3.5:1.

The temperature in step b1) is preferably in the range 80 to 180° C.

The alcohol(s) R¹²OH and/or R^{12′}OH formed in step b1) may be removed from the reaction mixture by distillation. The removal of the alcohol(s) R¹²OH and/or R^{12′}OH may increase the reaction rate and/or the product quality.

Separation of the obtained metal oxide nanoparticles from the mixture in step b2) may be done, for example, by filtration, or centrifugation.

In step b3) the metal oxide nanoparticles are preferably resuspended in a C₁-C₄alcohol, such as, for example, ethanol, 1-propanol and isopropanol; or a mixture of C₁-C₄alcohols.

The base used in step c1) is preferably selected from the group consisting of alkali metal alkoxides, alkali metal hydroxides, alkali metal salts of carboxylic acids, tetraalkylammonium hydroxides, trialkylbenzylammonium hydroxides and combinations thereof. More preferred, the base is selected from the group consisting of alkali metal alkoxides, especially potassium ethylate; alkali metal hydroxides, especially potassium hydroxide; alkali metal salts of carboxylic acids, especially potassium acrylate and methacrylate, and combinations thereof. Most preferred are alkali metal alkoxides.

The metal oxide nanoparticles may be treated in step b4) and/or c2) with volatile surface-modifying compound(s) selected from p-diketones, carboxylic acids and β-ketoesters and mixtures thereof, especially p-diketone(s), such as, for example, acetylacetone. The treatment with volatile surface-modifying compound(s) is prefereably done in step b4).

After treatment with base aliquots of nanoparticles dispersions in ethanol mixed with water (1:1 v/v) under vigorous stirring show a pH of greater than 3.5. That means, the obtained nanoparticles have low corrosivity.

In a particularly preferred embodiment the process for the preparation of a dispersion (coating composition) of the single, or mixed metal oxide nanoparticles is directed to the preparation a dispersion of TiO₂ nanoparticles and comprises the following steps:
a) preparing a mixture, comprising a metal alkoxide of formula Ti(OR¹²)₄ (Ia), metal halide of formula Ti(Hal)₄ (IIa), wherein R¹² is C₁-C₄alkyl, preferably methyl, ethyl, n-propyl, iso-propyl and n-butyl;
Hal is Cl; a solvent, a tertiary alcohol and optionally water,
b1) heating the mixture to a temperature of from 80° C. to 180° C.;
b2) separating the obtained TiO₂ nanoparticles from the mixture;
b3) resuspending the TiO₂ nanoparticles in a C₁-C₄alcohol, or a mixture of C₁-C₄alcohols;
b4) optionally treating the TiO₂ nanoparticles with a β-diketone(s), or salt(s) thereof;
c1) treating the TiO₂ nanoparticles with a base;
c2) optionally treating the TiO₂ nanoparticles with a β-diketone(s), or salt(s) thereof;
c3) optionally treating the TiO₂ nanoparticles with a compound of formula Me′(OR^{20′})_{z} (VII), or mixtures thereof, wherein

R^{20′} is a C₁-C₈ alkyl group, preferably a C₁-C₄ alkyl group;

Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V), preferably Ti (IV), Zr (IV), Sn (IV), Nb (V) and Ta (V); and

z equals to the oxidation state of metal; wherein

the ratio of moles of hydroxy groups of tertiary alcohol to total moles of Ti is in the range 1:2 to 6:1, preferably 1:2 to 4:1, most preferably 1:2 to 3.5:1;

the base is selected from the group consisting of alkali metal alkoxides, especially potassium ethylate; alkali metal hydroxides, especially potassium hydroxide; alkali metal salts of carboxylic acids, especially potassium acrylate and methacrylate and combinations thereof,

the solvent is selected from 2-methyltetrahydrofurane, tetrahydropyrane, 1,4-dioxane, cyclopentylmethyl ether, di-n-propyl ether, di-isobutyl ether, di-tert-butyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof;

the tertiary alcohol is selected from tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol), and wherein in step b1) the alcohol R¹²OH is removed by distillation.

In said embodiment the process comprises preferably the following steps:
a) preparing a mixture, comprising a metal alkoxide of formula Ti(OR¹²)₄ (Ia), metal halide of formula Ti(Hal)₄ (IIa), wherein R¹² is C₁-C₄alkyl, preferably methyl, ethyl, n-propyl, iso-propyl and n-butyl;
Hal is Cl; a solvent, a tertiary alcohol and optionally water,
b1) heating the mixture to a temperature of from 80° C. to 180° C.;
b2) separating the obtained TiO₂ nanoparticles from the mixture;
b3) resuspending the TiO₂ nanoparticles in a C₁-C₄alcohol, or a mixture of C₁-C₄alcohols;
b4) treating the TiO₂ nanoparticles with a p-diketone(s), or salt(s) thereof;
c1) treating the TiO₂ nanoparticles with a base.

The ratio of moles of hydroxy groups of tertiary alcohol to total moles of Ti is in the range 1:2 to 6:1, preferably 1:2 to 4:1, most preferably 1:2 to 3.5:1.

Separation of the obtained TiO₂ nanoparticles from the mixture in step b2) may be done, for example, by filtration, or centrifugation.

In step b3) the metal oxide nanoparticles are preferably resuspended in ethanol, 1-propanol and isopropanol; more preferably in ethanol.

The base used in step c1) is preferably an alkali metal alkoxide, especially potassium alkoxide. The treatment is usually carried out at a temperature of from 0° C. to 120° C., preferably from 20° C. to 100° C. The treatment can be carried out at normal or higher pressure and is preferably carried out at normal pressure.

The metal oxide nanoparticles can be treated in step b4) and/or c2) with p-diketone(s), such as, for example, compounds of formula H⁺L⁻, wherein L⁻ is defined below. The treatment with β-diketone(s) is preferably done in step b4). The treatment is usually carried out at a temperature of from 0° C. to 120° C., preferably at a temperature of from 20° C. to 100° C. The treatment is preferably carried out at normal or higher pressure, especially at normal pressure.

The metal oxide nanoparticles may be treated in step b4) and/or c2) with metal complex(es), comprising β-diketonate anion (L⁻). Such metal complexes are preferably compounds of formula Me(OR²⁰)ₓ(L⁻)_{y} (V), or mixtures thereof, wherein:

R²⁰ is a C₁-C₈ alkyl group, preferably a C₁-C₄ alkyl group, such as, for example, methyl, ethyl, n-propyl, iso-propyl and n-butyl;

L⁻ is a group of formula

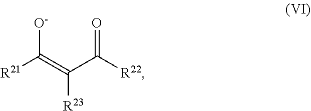

R²¹ and R²² are independently of each other a C₁-C₈alkyl group; a phenyl group, which may optionally be substituted by one or more C₁-C₄alkyl groups, or C₁-C₄alkoxy groups; a C₂-C₅heteroaryl group, which may optionally be substituted by one or more C₁-C₄alkyl groups, or C₁-C₄alkoxy groups; or a C₁-C₈alkoxy group,

R²³ is a hydrogen atom, a fluorine atom, a chlorine atom, or a C₁-C₈alkyl group, or

R²¹ and R²² together form a cyclic or bicyclic ring, which may optionally be substituted by one or more C₁-C₄alkyl groups;

Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V), preferably Zn (II), Ti (IV), Zr (IV), Hf (IV), Sn (IV), Nb (V) and Ta (V), more preferably Ti (IV), Zr (IV), Sn (IV), Nb (V) and Ta (V);

x is in the range from 0 to 4.9, preferably 0 to 4.5, y is in the range from 0.1 to 5, preferably 0.5 to 5, and the sum x+y equals to the oxidation state of metal.

The treatment is preferably carried out at a temperature of from 0° C. to 120° C., especially from 20° C. to 100° C. The treatment is preferably carried out at normal or higher pressure, especially at normal pressure.

The process may further comprise an optional step c3), wherein the dispersion, obtained in step c1), or in step c2) is treated with a compound of formula Me′(OR^{20′})_{z} (VII), or mixtures thereof, wherein

R^{20′} is a C₁-C₈ alkyl group, preferably a C₁-C₄ alkyl group;

Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V), preferably Ti (IV), Zr (IV), Sn (IV), Nb (V) and Ta (V); and

z equals to the oxidation state of metal.

The preferred β-diketonate anions are derived by abstraction of proton from acetylacetone, 2,4-hexanedione, 2,4-heptanedione, 3,5-heptanedione, 1,3-cyclohexanedione, 1,3-cyclopentanedione, especially acetylacetone.

Preferably, the metal oxide nanoparticles are treated in step b4) and/or c2) with pdiketone(s), such as, for example, acetylacetone. The treatment with β-diketone(s) is prefereably done in step b4).

After treatment with base aliquots of nanoparticles dispersions in ethanol mixed with water (1:1 v/v) under vigorous stirring show a pH of greater than 3.5. That means, the obtained nanoparticles have low corrosivity.

The metal oxide nanoparticles, in particular titanium dioxide nanoparticles, used in the coating compositions according to the present invention are preferably obtained by the above process.

The metal oxide, in particular titanium dioxide nanoparticles have a volume average particle size from 1 nm to 20 nm, preferably from 1 nm to 10 nm, more preferably from 1 nm to 5 nm. They can be resuspended, for example, in methanol, ethanol, propanol, 2-methoxy ethanol, iso-propanol, 2-iso-propoxy ethanol, 1-butanol, 1-methoxy-2-propanol. A film of the metal oxide, in particular titanium dioxide nanoparticles, which is dried and cured with UV light, shows a refractive index of greater than 1.70 (589 nm), especially of greater than 1.80, very especially of greater than 1.90.

The coating compositions of the present invention may be used for coating diffractive optical elements (DOEs), holograms, manufacturing of optical waveguides and solar panels, light outcoupling layers for display and lighting devices, high dielectric constant (high-k) gate oxides and interlayer high-k dielectrics, anti-reflection coatings, etch and CMP stop layers, optical thin film filters, optical diffractive gratings and hybrid thin film diffractive grating structures, high refractive index abrasion-resistant coatings, in protection and sealing (OLED), or organic solar cells.

In a particularly preferred embodiment the coating composition (dispersion) according to the present invention comprises
i) titanium dioxide nanoparticles, wherein the volume average diameter (Dᵥ50) of the titanium dioxide nanoparticles is in the range of 1 to 10 nm, especially 1 to 5 nm; the nanoparticles comprise at least one volatile surface-modifying compound selected from ethanol and acetylacetone and mixtures thereof, wherein the total amount of volatile surface-modifying compounds is in the range of from 15 to 50% by weight, especially from 20 to 40% by weight, very especially from 25 to 35% by weight based on the amount of metal oxide nanoparticles; and
ii) a solvent which is selected from C₂-C₄alcohols, especially ethanol, 1-propanol and isopropanol; ketones, especially acetone, 2-butanone, 2-pentanone, 3-pentanone, cyclopentanone and cyclohexanone; ether alcohols, especially 1-methoxy-2-propanol; mixtures thereof.

Preferably, the coating composition comprises less than 1% w/w of water.

Preferably, the coating composition does not comprise an organic radical photoinitiator.

The pH of the coating composition is in the range of 3 to 10, preferably 3 to 7 as measured in a 1:1 mixture with water.

Preferably, the coating composition does not comprise a binder.

The coating composition accoding to the present invention may comprise further metal oxide, or mixed metal oxide nanoparticles having a Dᵥ50 which is larger than the Dᵥ50 of the metal oxide nanoparticles prepared by the method of the present invention. The further metal oxide, or mixed metal oxide nanoparticles have a Dᵥ50 in the range of 20 to 100 nm, especially 20 to 60 nm, very especially 20 to 40 nm. The metals of the metal oxide, or mixed metal oxide nanoparticles are selected from Zn (II), In (III), Sc (III), Y (III), La (III), Ce (IV), Ti (IV), Zr (IV), Hf (IV), Sn (IV), V (IV), Nb (V) and Ta (V), preferably Zn (II), Ce (IV), Ti (IV), Zr (IV), Hf (IV), Sn (IV), V (IV), Nb (V) and Ta (V), more preferably Zn(II), Ti (IV), Zr (IV) and Sn (IV) or mixtures thereof.

A coating obtainable from the coating composition according to the present invention has a refractive index of greater than 1.7, especially of greater than 1.8, very especially of greater than 1.9.

A method for forming the coating having a high refractive index on a substrate comprises the steps of:
a) providing a substrate, preferably carrying a surface relief nano- and/or microstructure;
b) applying the coating composition according to the present invention to the substrate by means of wet coating, or printing;
c) removing the solvent; and
d) exposing the dry coating to actinic radiation, especially UV-light.

In addition, the present invention relates to security, or decorative elements, comprising a substrate, which may contain indicia or other visible features in or on its surface, and on at least part of the said substrate surface, a coating according to the present invention, or a coating obtained according to the method of the present invention.

The expression “surface relief” is used to refer to a non-planar part of the surface of a substrate, or layer, and typically defines a plurality of elevations and depressions. In particularly advantageous embodiments, the surface relief structure is a diffractive surface relief structure. The diffractive surface relief structure may be a diffraction grating (such as a square grating, sinusoidal grating, sawtooth grating or blazed grating), a hologram surface relief or another diffractive device that exhibits different appearances, e.g. diffractive colours and holographic replays (such as, for example, a lens, or microprism), at different viewing angles. For the purposes of this specification, such surface relief structures will be referred to as diffractive optically variable image devices (DOVIDs).

In embodiments, the high refractive index (HRI) layer obtained from the coating composition of the present invention may further comprise a dispersion of scattering particles having a dimension along at least one axis such that the HRI layer exhibits a first colour when viewed in reflection and a second, different colour when viewed in transmission.

The coating of the present invention can be used in the manufacture of surface relief micro- and nanostructures, such as, for example, optically variable devices (OVD), such as, for example, a hologram.

The method for forming a surface relief micro- and/or nanostructure on a substrate comprising the steps of:
a) forming a surface relief micro- and/or nanostructure on a discrete portion of the substrate;
b) depositing the coating composition according to the present invention on at least a portion of the surface relief micro- and/or nanostructure;
c) removing the solvent; and
d) curing the dry coating by exposing it to actinic radiation, especially UV-light.

A further specific embodiment of the invention concerns a preferred method for forming a surface relief micro- and/or nanostructure on a substrate, wherein step a) comprises
a1) applying a curable compound to at least a portion of the substrate;
a2) contacting at least a portion of the curable compound with surface relief microand/or nanostructure forming means; and
a3) curing the curable compound.

Alternatively, the method for forming a surface relief micro- and/or nanostructure on a substrate comprises the steps of
a′) providing a sheet of base material, said sheet having an upper and lower surface;
b) depositing the coating composition according to the present invention on at least a portion of the upper surface;
c′) removing the solvent;
d′) forming a surface relief micro- and/or nanostructure on at least a portion of the coating composition, such that said micro- and/or nanostructure is formed also in the base material, and
e′) curing the coating composition by exposing it to actinic radiation, especially UV-light.

Yet a further specific embodiment of the invention concerns a preferred method for forming a surface relief micro- and/or nanostructure on a substrate, comprising the steps of:
a″) providing a sheet of base material, said sheet having an upper and lower surface;
b″) depositing the coating composition according to the present invention on at least a portion of the upper surface;
c″) removing the solvent;
d″) curing the dry coating by exposing it to actinic radiation, especially UV-light; and
e″) forming a surface relief micro- and/or nanostructure on at least a portion of the coating composition, such that said micro- and/or nanostructure is formed also in the base material.

The (coating) composition of the present invention may be applied to the substrate by means of conventional printing press such as gravure, flexographic, inkjet, lithographic, offset, letterpress intaglio and/or screen process, or other printing process.

In another embodiment the composition may be applied by coating techniques, such as spraying, dipping, casting or spin-coating.

Preferably the printing process is carried out by gravure, flexographic, or by ink jet printing.

The resulting coatings, comprising the TiO₂ nanoparticles, are transparent in the visible region. The transparent TiO₂ nanoparticles containing layer has a thickness from 20 nm to 1 μm, especially from 20 nm to 500 nm after drying. The TiO₂ nanoparticles containing coating is preferably dried at below 120° C. to avoid damage of organic substrates and/or coating layers.

The resulting products may be overcoated with a protective coating to increase the durability and/or prevent copying of the security element. The protective coating is preferably transparent or translucent. The protective coating may have refractive index of from about 1.2 to about 1.75. Examples of such coatings are known to the skilled person. For example, water borne coatings, UV-cured coatings or laminated coatings may be used. Examples for typical coating resins will be given below. Coatings having a very low refractive index are, for example, described in U.S. Pat. No. 7,821,691, WO2008011919 and WO2013117334.

The composition may be coated onto organic foils via gravure printing followed by a transparent overcoat subsequently being UV-cured (e.g. Lumogen OVD Varnish 311®).

The high refractive index coating according to the present invention may represent the dielectric layer in a so-called Fabry Perot Element. Reference is made, for example, to (EP1504923, WO01/03945, WO01/53113, WO05/38136, WO16173696). In said embodiment the security element comprises a mutlilayer structure capable of interference, wherein the multilayer structure capable of interference has a reflection layer, a dielectric layer, and a partially transparent layer (EP1504923, WO01/03945, WO01/53113, WO05/38136, WO16173696), wherein the dielectric layer is arranged between the reflection layer and the partially transparent layer.

Suitable materials for the reflective layer include aluminum, silver, copper mixtures or alloys thereof. The partially transparent layer can be composed of a semi-opaque materials, including metals such as chromium, nickel, titanium, vanadium, cobalt, and palladium, as well as other metals such as iron, tungsten, molybdenum, niobium and aluminum having a suitable thickness of about 3 to 15 nm. Various combinations and alloys of the above metals may also be utilized, such as Inconel (Ni—Cr—Fe). Other partially transparent materials include metal compounds such as metal fluorides, metal oxides, metal sulfides, metal nitrides, metal carbides, metal phosphides, metal selenides, metal silicides, and combinations thereof.

The reflective layer is preferably an aluminum or silver layer and the dielectric layer is preferably formed from the (surface functionalized) TiO₂ nanoparticles of the present invention.

The high refractive index coating according to the present invention may represent the partially transparent layers of a Fabry-Perot resonator system and/or the reflection layer. The reflection layer may be also partially transparent.

In a further embodiment, the high refractive index coating according to the present invention may represent the semitransparent layer of a Fabry-Pérot resonator system and the second semitransparent layer may be represented by a continuous metallic layer, deposited, for example, by thermal evaporation method, or by a layer, comprising discrete metallic nanostructures capable of absorption of light in the visible wavelength range due to surface plasmon resonance, which may be deposited through vapor-phase metallization, for example, on a surface relief nanostructure, or by printing, or coating of compositions, comprising metal nanoparticles, especially copper, silver or gold nanoparticles (“plasmonic layer”, see, for example, WO2011/064162, WO2012/176126, WO2020/083794 and WO2020/224982). The resulting optical effect observed from the side of the second semitransparent layer is a colored metallic reflection, modified by the interference color of the dielectric system in reflection. Observed from the high refractive index coating, the optical effect in reflection is the pure interference color resulting from the Fabry-P6rot resonator system. In transmission, observed from either the first surface or the second surface, the color is a subtractive mix of the absorption color from the plasmonic layer and the complementary color of the Fabry-Pérot resonator's interference color.

The plasmonic layer may also be manufactured by depositing a metal precursor composition on the underlying substrate or functional layer and exposing it to heat or actinic radiation as described, for example, in WO2016/170160A1, WO2018/210597 and WO2019/020682A1.

The high refractive index coating according to the present invention may be used in the fabrication of thin-film multilayer antireflective or reflective elements and coatings, comprising stacks of layers with different refractive indices. Reference is made, for example, to H. A. Macleod, “Thin-Film Optical Filters”, published by Institute of Physics Publishing, 3^{rd} edition, 2001; EP2806293A2 and DE102010009999A1.

In an additional embodiment the present invention is directed to a security, or decorative element, comprising a substrate, which may contain indicia or other visible features in or on its surface, and on at least part of the said substrate surface, a coating according to the present invention, or a coating obtained according to the method according to present invention.

The security element may comprise one, or more further functional layers, which are selected from black layers, white layers, continuous metallic layers, deposited, for example by thermal evaporation method, layers, comprising discrete metallic nanostructures capable of absorption of light in the visible wavelength range due to surface plasmon resonance, which may be deposited through vapor-phase metallization, for example, on a surface relief nanostructure, or by printing or coating of compositions, comprising metal nanoparticles, layers comprising surface relief nano- and/or microstructures, such as DOEs, micromirrors, microlenses, layers comprising magnetic pigments, cholesteric liquid crystal layers, fluorescent layers, interference layers, such as, for example, a Fabry-Perot stack; colored layers, IR-absorbing layers, colored IR-transparent layers, conductive layers, adhesive and release layers.

The functional layers might be fully, or partially printed on the substrate and/or underlying layer.

The security element of the present invention might be provided as a laminate onto a security document, or as a window on the security document, or embedded as a (windowed) thread into the security document.

The security document of the present is selected from a banknote, a tax stamp, an ID-card, avoucher, an entrance ticket and a label.

If applied on top of surface relief nano- and/or microstructure, the high refractive index layer may conformally adhere to the said surface relief nano- and/or microstructure, or at least partially flatten it. Reference is made to EP2042343A1 and WO2011116419. (Partial) flattening means in this context that the difference in distance between the highest features of the relief structure and the lowest features of the relief structure is reduced in the coated structure, compared to the uncoated one. Full flattening means in this context that the difference in distance between the highest features of the relief structure and the lowest features of the relief structure is zero.

The HRI coating composition of the present invention may be applied by printing to at least a part of surface relief nano- and/or microstructure, or to the whole structure.

In a particularly preferred embodiment the present invention is directed to
a security element, comprising in this order
i) an overprint varnish layer, a PET layer, an adhesive layer, or a release layer;
ii) a colorshift layer, such as, for example, a cholesteric liquid crystal layer;
iii) a layer of a partially black print, or negative microtext;
iv) the HRI coating layer of the present invention, which flatten the surface relief nano- and/or microstructure (v);
v) a surface relief nano- and/or microstructure;
vi) optionally a PET layer;
vii) optionally functional layer(s), comprising fluorescent, magnetic, NIR and conductive materials; and
viii) an overprint varnish layer, a PET layer, an adhesive layer, or a release layer; or
a security element, comprising in this order
i) an overprint varnish layer, a PET layer, an adhesive layer, or a release layer;
ii) a colorshift layer, such as, for example, a cholesteric liquid crystal layer;
iii) a layer of a partially black print, or negative microtext;
iiia) optionally a planarization layer;
iv) the HRI coating layer of the present invention, which conformally adhere to the the surface relief nano- and/or microstructure (v);
v) a surface relief nano- and/or microstructure;
vi) optionally a PET layer;
vii) optionally functional layer(s), comprising fluorescent, magnetic, NIR and conductive materials; and
viii) an overprint varnish layer, a PET layer, an adhesive layer, or a release layer; In another preferred embodiment the present invention is directed to security devices described, in principal, in WO2009/066048.

WO2009/066048 relates to security devices (10) comprising a first and a second layer (11a, 11b) of a colourshifting material at least partially overlying each other and each having different colourshifting properties and, at least partially applied over an exposed surface of one of the colourshifting layers (11a, 11b), a light control layer (12) having a surface structure which modifies the angle of reflected light, such that light reflected by the security device is seen at a different viewing angle and in at in least one region, a light absorbing layer (30) between the two colourshifting layers (11a, 11b). The HRI coating of the present invention may be the light control layer 12 that would allow to overvarnish and flatten the light control layer 12 with an overprint varnish. Alternatively, the light control layer 12 could be overcoated with HRI composition of the present invention.

In FIG. 16 of WO2009/066048 the security device 10 comprises a first layer 11a of an optically variable liquid crystal material and a second layer 11b of an optically variable liquid crystal material, which exhibits different reflective characteristics to the first layer 11a. A partial absorbing layer 30 is applied between the first and second liquid crystal layers 11a and 11b. A light control layer 12, comprising a series of parallel linear microprisms, is applied to the second liquid crystal layer 11b. The light control layer 12 may be a partial layer, as described in reference to FIG. 4, or a full layer. If the device 10 is intended to be viewed in reflection, it is preferable to have an additional dark absorbing layer 31 present under the first liquid crystal layer 11a.

The application of a partial absorbing layer 30 between the two liquid crystal layers 11a, 11b creates two optically variable regions, Regions A and B. In Region A there is no absorbing layer 30 between the two liquid crystal layers 11a, 11b such that the wavelength of reflected light, at any given angle of incidence, is a result of the additive mixing of the individual wavelengths of light reflected from the two liquid crystal layers 11a, 11b. In Region B there is an absorbing layer 30 between the two liquid crystal layers and the wavelength of reflected light, at any given angle of incidence, is solely the reflected light from the second liquid crystal layer 11b.

The absorbing layer 31 which lies under the first liquid crystal film layer 11a may be applied in the form of a design, creating a further optically variable Region C, as shown in FIG. 17 OF WO2009/066048. In Region C there is no absorbing layerunder either of the liquid crystal layers 11a, 11b and when the device 10 is positioned on a reflective background, the intensity of the transmitted colour reflected back through the liquid crystal layers 11a, 11 b saturates the reflective colour. The transmitted and reflected colours are complementary, for example, a red to green colourshift in reflection is seen as a cyan to magenta colourshift in transmission.

In another preferred embodiment the present invention is directed to a security device 10 described, in principal, in FIG. 1 of of WO2013/017865. FIG. 1 of WO2013/017865 illustrates a security device 10, comprising a carrier substrate 11.

This substrate 11 is preferably a translucent or transparent polymeric film such as polyethylene (PET) or biaxially oriented polypropylene (BOPP). A light deflection structure 12 is applied to the substrate 11, either as a separate layer or formed in a surface of the substrate 11. The light deflection structure 12 is one that has facets or lenses which, when provided with a reflective coating 14 strongly reflects light substantially back to the light source when the light source is substantially parallel to the normal of the substrate and when the light source is away from the normal to the security device 10. One form of suitable light reflection structure 12 comprises a prismatic structure comprising a series of adjacent parallel linear prisms 17 with planar facets arranged to form a grooved surface. These can be formed by either thermally embossing the prisms into the substrate 11 or by casting the prisms into a resin which is curable by ultra-violet light or e-beam irradiation. Examples of other suitable light deflection structures 12 include, but are not limited to, a ruled array of tetrahedra, an array of square pyramids, an array of corner-cube structures, an array of hexagonal-faced corner-cubes and a saw-tooth prismatic array. Other structures may also be used, such as Fresnel lenses and lenticular lenses. The light deflection structure 12 is then provided with either positive or negative indicia 13 by coating or covering selected regions 15 of the light deflection structure 12 with the HRI coating layer 14 of the present invention, whilst leaving other regions 16 uncoated or uncovered.

Security devices of the sort described above can be incorporated into or applied to any article for which an authenticity check is desirable. In particular, such devices may be applied to or incorporated into documents of value such as banknotes, passports, driving licences, cheques, identification cards etc. The security device or article can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A0059056. EP-A-0880298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices. The security device or article may be subsequently incorporated into a paper or polymer base substrate so that it is viewable from both sides of the finished security substrate. Methods of incorporating security elements in such a manner are described in EP-A-1 141480 and WO-A-03054297. In the method described in EP-A-1 141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-72350, EP-A-724519, WO-A-03054297 and EP-A1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Typically the security product includes banknotes, credit cards, identification documents like passports, identification cards, driver licenses, or other verification documents, pharmaceutical apparel, software, compact discs, tobacco packaging and other products or packaging prone to counterfeiting or forgery.

The substrate may comprise any sheet material. The substrate may be opaque, substantially transparent or translucent, wherein the method described in WO08/061930 is especially suited for substrates, which are opaque to UV light (non-transparent). The substrate may comprise paper, leather, fabric such as silk, cotton, tyvac, filmic material or metal, such as aluminium. The substrate may be in the form of one or more sheets or a web.

The substrate may be mould made, woven, non-woven, cast, calendared, blown, extruded and/or biaxially extruded. The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, polypropylene propafilm, polyvinylchloride, rigid PVC, cellulose, tri-acetate, acetate polystyrene, polyethylene, nylon, acrylic and polytherimide board. The polythyleneterephthalate substrate may be Melinex type film orientated polypropylene (obtainable from DuPont Films Willimington Delaware product ID Melinex HS-2).

The substrates being transparent films or non-transparent substrates like opaque plastic, paper including but not limited to banknote, voucher, passport, and any other security or fiduciary documents, self adhesive stamp and excise seals, card, tobacco, pharmaceutical, computer software packaging and certificates of authentication, aluminium, and the like.

In a preferred embodiment of the present invention the substrate is a non-transparent (opaque) sheet material, such as, for example, paper. Advantageously, the paper may be precoated with an UV curable lacquer. Suitable UV curable lacquers and coating methods are described, for example, WO2015/049262 and WO2016/156286.

In another preferred embodiment of the present invention the substrate is a transparent or translucent sheet material, such as, for example, polyethylene terephthalate, polyethylene naphthalate, polyvinyl butyral, polyvinyl chloride, flexible polyvinyl chloride, polymethyl methacrylate, poly(ethylene-co-vinyl acetate), polycarbonate, cellulose triacetate, polyether sulfone, polyester, polyamide, polyolefins, such as, for example, polypropylene, and acrylic resins. Among these, polyethylene terephthalate and polypropylene are preferred. The flexible substrate is preferably biaxially oriented.

The forming of an optically variable image on the substrate may comprise depositing a curable composition on at least a portion of the substrate, as described above. The curable composition, generally a coating or lacquer may be deposited by means of gravure, flexographic, ink jet and screen process printing. The curable lacquer may be cured by actinic radiations, preferably ultraviolet (UV) light or electron beam. Preferably, the curable lacquer is UV cured. UV curable lacquers are well known and can be obtained from e.g. BASF SE. The lacquers exposed to actinic radiations or electron beam used in the present invention are required to reach a solidified stage when they separate again from the imaging shim in order to keep the record in their upper layer of the sub-microscopic, holographic diffraction grating image or pattern (optically variable image, OVI). Particularly suitable for the lacquer compositions are mixtures of typical well-known components (such as photoinitiators, monomers, oligomers. levelling agents etc.) used in the radiation curable industrial coatings and graphic arts. Particularly suitable are compositions containing one or several photo-latent catalysts that will initiate polymerization of the lacquer layer exposed to actinic radiations. Particularly suitable for fast curing and conversion to a solid state are compositions comprising one or several monomers and oligomers sensitive to free-radical polymerization, such as acrylates, methacrylates or monomers or/and oligomers, containing at least one ethylenically unsaturated group, examples have already been given above. Further reference is made to pages 8 to 35 of WO2008/061930.

The UV lacquer may comprise an epoxy monomer from the CRAYNOR@ Sartomer Europe range (10 to 60%) and one or several acrylates (monofunctional and multifunctional), monomers which are available from Sartomer Europe (20 to 90%) and one, or several photoinitiators (1 to 15%) such as Darocure® 1173 and a levelling agent such as BYK@361 (0.01 to 1%) from BYK Chemie. The UV lacquer may also be used for overcoating.

The epoxy monomer is selected from aromatic glycidyl ethers and aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The one or several acrylates are preferably multifunctional monomers which are selected from trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA) and or mixtures thereof.

The photoinitiator may be a single compound, or a mixture of compounds. Examples of photoinitiators are known to the person skilled in the art and for example published by Kurt Dietliker in “A compilation of photoinitiators commercially available for UV today”, Sita Technology Textbook, Edinburgh, London, 2002.

The photoinitiator may be selected from acylphosphine oxide compounds, benzophenone compounds, alpha-hydroxy ketone compounds, alpha-alkoxyketone compounds, alpha-aminoketone compounds, phenylglyoxylate compounds, oxime ester compounds, mixtures thereof and mixtures and mixtures thereof.

The photoinitiator is preferably a blend of an alpha-hydroxy ketone, alpha-alkoxyketone or alpha-aminoketone compound and a benzophenone compound; or a blend of an alpha-hydroxy ketone, alpha-alkoxyketone or alpha-aminoketone compound, a benzophenone compound and an acylphosphine oxide compound.

The curable composition is preferably deposited by means of gravure or flexographic printing. The curable composition can be coloured.

An OVD is cast into the surface of the curable composition with a shim having the OVD thereon, the holographic image is imparted into the lacquer and instantly cured via a UV lamp, becoming a facsimile of the OVD disposed on the shim (U.S. Pat. Nos. 4,913,858, 5,164,227, WO2005/051675 and WO2008/061930).

The curable coating composition according to the present invention may be applied to the OVD by means of conventional printing press such as gravure, ink-jet, rotogravure, flexographic, lithographic, offset, letterpress intaglio and/or screen process, or other printing process.

Preferably, the HRI layer, which is printed over the OVD, is also sufficiently thin as to allow viewing in transmission and reflectance. In other words the whole security element on the substrate allows a viewing in transmission and reflectance.

The curable composition may further comprise modifying additives.

Specific additives can be added to the composition to modify its chemicals and/or physical properties. Polychromatic effects can be achieved by the introduction of (colored) inorganic and/or organic pigments and/or solvent soluble dyestuffs into the ink, to achieve a range of coloured shades. By addition of a dye the transmission colour can be influenced. By the addition of fluorescent or phosphorescent materials the transmission and/or the reflection colour can be influenced.

Suitable colored pigments especially include organic pigments selected from the group consisting of azo, azomethine, methine, anthraquinone, phthalocyanine, perinone, perylene, diketopyrrolopyrrole, thioindigo, dioxazine, iminoisoindoline, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, the 2,9-dichloro-quinacridone in platelet form described in WO08/055807, or a mixture or solid solution thereof.

Plateletlike organic pigments, such as plateletlike quinacridones, phthalocyanine, fluororubine, dioxazines, red perylenes or diketopyrrolopyrroles can advantageously be used.

Suitable colored pigments also include conventional inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate, Prussian blue, Fe₃O₄, carbon black and mixed metal oxides.

Examples of dyes, which can be used to color the curable composition, are selected from the group consisting of azo, azomethine, methine, anthraquinone, phthalocyanine, dioxazine, flavanthrone, indanthrone, anthrapyrimidine and metal complex dyes. Monoazo dyes, cobalt complex dyes, chrome complex dyes, anthraquinone dyes and copper phthalocyanine dyes are preferred.

The surface relief micro- and nanostructures are, for example, microlense arrays, micromirror arrays, optically variable devices (OVDs), which are, for example, diffractive optical variable image s (DOVIs). The term “diffractive optically variable image” as used herein may refer to any type of holograms including, for example, but not limited to a multiple plane hologram (e.g., 2-dimensional hologram, 3-dimensional hologram, etc.), a stereogram, and a grating image (e.g., dot-matrix, pixelgram, exelgram, kinegram, etc.).

Examples of an optically variable device are holograms or diffraction gratings, moire grating, lenses etc. These optical micro- and nanostructured devices (or images) are composed of a series of structured surfaces. These surfaces may have straight or curved profiles, with constant or random spacing, and may even vary from microns to millimetres in dimension. Patterns may be circular, linear, or have no uniform pattern. For example a Fresnel lens has a micro- and nanostructured surface on one side and a plane surface on the other. The micro- and nanostructured surface consists of a series of grooves with changing slope angles as the distance from the optical axis increases. The draft facets located between the slope facets usually do not affect the optical performance of the Fresnel lens.

A further aspect of the present invention is the use of the element as described above for the prevention of counterfeit or reproduction, on a document of value, right, identity, a security label or a branded good.

The compositions, comprising the metal oxide nanoparticles of the present invention, may be applied on top of the surface relief micro- and nanostructures in transparent windows, security threads and foils on the document of value, right, identity, a security label or a branded good.

The coatings of the present invention may be used in a method of manufacturing a security device described in EP2951023A1 comprising:
(a) providing a transparent substrate,
(b) applying a curable transparent material to a region of the substrate;
(c) in a first curing step, partially curing the curable transparent material by exposure to curing energy;
(d) applying a layer of the coating of the present invention (reflection enhancing material) to the curable transparent material;
(e) forming the partially cured transparent material and the layer of coating composition such that both surfaces of the layer of the coating of the present invention follow the contours of an optically variable effect generating relief structure,
(f) in a second curing step, fully curing the formed transparent material by exposure to curing energy such that the relief structure is retained by the formed transparent material.

Various aspects and features of the present invention will be further discussed in terms of the examples. The following examples are intended to illustrate various aspects and features of the present invention.

### EXAMPLES

Measurement of pH of Dispersions in Ethanol

The aliquots of nanoparticles dispersions in ethanol were mixed with deionized water (1:1 v/v) under vigorous stirring and pH was measured in the resulting mixture by means of pH meter.

Measurement of refractive indices of the coatings by ellipsometry

The nanoparticles-containing dispersions were coated onto silicon wafers to obtain coatings with thicknesses of at least 200 nm (thickness was measured with KLA Tencor Alpha-Step D-100 Stylus Profiler). The data was acquired in Reflectance mode at 65°, 70° and 75° angles, using Woollam M-2000-R19 ellipsometer, and the obtained data was fitted using the Cauchy model with WVase32 software.

Measurement of Particle Size Distribution by DLS

The measurements were performed using Malvern Zetasizer Nano ZS device with ca. 3% w/w dispersions of nanoparticles in a suitable solvent. Measurements in ethanol were performed in presence of acrylic acid (15% w/w of acrylic acid relative to particles weight was added). Measurements in water were performed in presence of 1 mM HCl. D10, D50 and D90 values are given for volume distributions.

Measurement of Solids Content

The solids content of powders and dispersions was determined using Mettler-Toledo HR-73 halogen moisture analyzer at 100° C.

Measurement of Total Amount of Volatile Surface-Modifying Compounds

The total amount of volatile surface-modifying compounds was determined in dispersions after neutralization step as weight loss in the range 200-600° C. relative to the residue at 600° C. in thermogravimetric analysis using TGA/DSC 3+ thermogravimetric analyser from Mettler-Toledo, with the proviso that the highest boiling solvent in the composition has a boiling point of below about 170° C. About 20 to 40 mg of dispersion sample was filled in a tared aluminum crucible, sealed immediately to avoid weight loss before experiment and weighed. The exact mass of sample was recorded. The aluminum crucible is put in the TGA oven at 30° C. The lid of the crucible is pierced at the time. Heating rate was 10° C./min, the measurements were done under nitrogen flow in the range from 30 to 600° C.

XRD Measurements

Powder samples were loaded on to a special flat plate Silicon sample holder, taking special care on producing a flat and smooth surface with the correct alignment to the sample holder zero-reference to avoid large systematic errors. The silicon sample holder was manufactured such that the it does not produce sharp diffraction features but only a weak and smooth background.

The sample on the sample holder was loaded in to a Panalytical ′XPert3 Powder equipped with a sealed Cu tube producing a characteristic X-ray lines Cu K_{α} and Cu K_{β} with wavelengths Δ₁=1.54056 Å (Cu K_{α1}), Δ₂=1.54439 Å (Cu K_{α2}), I₂/I₁=0.5 and Δ₂=1.3922 Å (Cu K_{β}). The contribution of the latter (Cu K_{β}) was removed introducing a Nifilter on the incident beam of the diffractometer right after the Cu-tube.

Diffraction data was collected from 10 to 80 °2θ, using a step of 0.026 °2θ for a total time of 2 h and spinning the sample around its axis at a rate of 0.13 rate/s in order to increase the sampling statistic.

The analysis of the diffraction patterns in terms of crystallographic phase analysis and average domain size was performed using the Panalytical HighScore software (v 4.8+) and the Bruker Topas6 program, obtaining consistent results.

The volume weighted domain size of diffraction (Dv) was evaluated using the Scherrer equation (B. E. Warren, X-Ray Diffraction, Addison-Wesley Publishing Co., 1969) Dv=K Δ/[β cos(θ)], where K(˜1) is the shape factor, dependent on the shape and reciprocal space direction, λ the wavelength, β the integral breadth of the diffraction peak and θ the scattering half-angle. To ensure a correct determination of the Dv, the integral breadth β was amended of the instrumental contribution. To achieve this, the line-broadening of the powder reference material LaB₆ was measured and evaluated according to the same procedure, as described above.

### Example 1

Step 1. Synthesis of TiO₂ Nanoparticles

All operations were carried out under dry nitrogen atmosphere. Di(propylene glycol) dimethyl ether (400 g) was placed in a 1 L double-wall reactor, equipped with a mechanical stirrer and a distillation head with a Liebig condenser. 2,5-Dimethyl-2,5-hexanediol (234 g) was added, followed by addition of tetraethyl orthotitanate (273.8 g). The mixture was heated to 65° C. over 30 min with stirring and was kept for 15 min at this temperature. Titanium tetrachloride (75.9 g) was added dropwise with stirring and the reaction mixture was heated to 130° C. over 2 h, during which time distillation has begun. The reaction mixture was stirred at 125-130° C. internal temperature (with constant jacket temperature) for 3 h, upon which time distillate was collected and the beige precipitate has formed. After that, the internal reaction temperature was increased to 150° C. over 2 h and stirring was continued for 5 h at this temperature. In total, 315 g distillate was collected.

The reaction mixture was cooled to 77° C., absolute ethanol (200 g) was added and stirring was continued for 5 h at 77° C. The mixture was cooled to 25° C., isopropanol (300 g) was added, the mixture was stirred for 30 min at 25° C. and filtered under vacuum through a paper filter (20 μm pore size). The product was washed on the filter with isopropanol (1000 g) and absolute ethanol (300 g) and dried on the filter for 1 min. The beige powder of TiO₂ nanoparticles agglomerates was obtained (247 g). Solids content at 100° C. 61.7% w/w. XRD analysis showed anatase to be the predominant phase with crystalline domain size of 3.1±0.3 nm. D10(v)=2.1 nm, D50(v)=3.0 nm, D90(v)=4.8 nm (in 1 mM HCl in water).

Step 2. Neutralization/Re-Dispersion of TiO₂ Nanoparticles

The powder, obtained in Step 1 (227 g), was resuspended in absolute ethanol (450 g). The temperature of the mixture was raised to 75° C., acetylacetone (5.6 g) was added and the pH of the mixture was brought to 4.5 via dropwise addition of 24% w/w potassium ethylate solution in absolute ethanol (98.6 g) with stirring at 75° C. Upon addition of potassium ethylate solution the turbidity of the mixture was strongly reduced due to the re-dispersion of TiO₂ nanoparticles agglomerates. The mixture was cooled to 25° C. and filtered through the depth filter sheet (Seitz@ KS 50) under 2.5 Bar pressure to remove the formed potassium chloride along with the traces of non-re-dispersed TiO₂ nanoparticles. The brownish filtrate, containing re-dispersed TiO₂ nanoparticles, was collected (730 g). Solids content at 100° C. 18.1% w/w. D10(v)=2.0 nm, D50(v)=2.8 nm, D90(v)=4.2 nm (in presence of acrylic acid in ethanol). Total amount of volatile surface-modifying compounds as determined by thermogravimetric analysis (weight loss in the range 200-600° C. relative to the residue at 600° C.) was found to be 28%.

### Application Example 1

a) Preparation of Coating Compositions

The dispersion, obtained in Example 1, was diluted to 10% w/w solid content with absolute ethanol.

b) Preparation of UV-Cured Coatings with High Refractive Index

The coating composition, prepared in Application Example 1a), was spin-coated onto polished silicon wafers. The coating was dried with an air-dryer at 80° C. for 10 seconds to evaporate solvent and the dry coating was cured using a medium pressure mercury UV lamp (total UV dose ca. 500 mJ/cm²) to obtain a cured coating. Thickness and refractive index at 589 nm wavelength of the cured coating were found to be 155 nm and 2.03, respectively.

### Application Example 2

Evaluation of Chemical Fastness Properties and Mechanical Stability of Coatings

A PET foil (Melinex 506) was coated with a UV-curable varnish (Lumogen OVD 311, commercially available from BASF) using a wired hand-coater #1 and thus obtained coating was cured using a medium pressure mercury UV lamp (total UV dose ca. 350 mJ/cm²). The coating composition, prepared in Application Example 1a), was coated onto this substrate using a wired K Hand Coater #1 (6 μm wet coating thickness), dried with an air-dryer at 80° C. for 10 seconds and cured using a medium pressure mercury UV lamp (total UV dose ca. 500 mJ/cm²) to obtain a cured coating.

Chemical fastness was evaluated by immersing the coated foil (before and after UV-curing) into absolute ethanol, or 1-methoxy-2-propanol for 30 minutes at room temperature. After that, the foils were dried with an air-dryer at room temperature. The dry foils were assessed visually (reflectance color, caused by interference, was observed) using a grayscale note from 0 to 4 (0—coating completely disappeared, 1—major change; more than 50% damaged, 2—considerable change; less than 50% damaged, 3—minor changes, 4—coating unchanged), as compared to the untreated reference.

Mechanical stability of the coatings before and after UV-curing was evaluated by manually rubbing the coating once with a nylon glove and visually assessing the behavior using a note of 0 or 1 (0—white traces on the coating, 1—coating unchanged).

TABLE 1
Evaluation of chemical and mechanical stability of
coatings before and after UV curing.

| | | 1-Methoxy-2- | Acetic | Mechanical |
|---|---|---|---|---|
| | Ethanol | propanol | Acid | Stability |
| Before UV curing | 0 | 0 | 0 | 0 |
| After UV curing | 4 | 4 | 4 | 1 |

### Example 2

Treatment of TiO₂ dispersions with metal alcoholates
a) The dispersion obtained in step 2 of Example 1 was diluted with 2-butanone to adjust the solid content to 10% w/w. Tetraethyl orthotitanate (27 mg, 0.12 mmol of Ti) was added to the thus obtained dispersion (4 g) with stirring and the mixture was stirred at 50° C. for 12 h under nitrogen.
b) The dispersion, obtained in step 2 of Example 1 was diluted with 2-butanone to adjust the solid content to 10% w/w. A solution of zirconium tetra-1-propylate (70% w/w in 1-propanol, 56 mg of solution, 0.12 mmol Zr) was added to the thus obtained dispersion (4 g), with stirring and the mixture was stirred at 50° C. for 12 h under nitrogen.
c) The dispersion, obtained in step 2 of Example 1 was diluted with 2-butanone to adjust the solid content to 10% w/w. Niobium pentaethylate (38 mg, 0.12 mmol of Nb) was added to the thus obtained dispersion (4 g) with stirring and the mixture was stirred at 50° C. for 12 h under nitrogen.
d) The dispersion obtained in step 2 of Example 1 was diluted with 2-butanone to adjust the solid content to 10% w/w. Tantalum pentaethylate (49 mg, 0.12 mmol of Ta) was added to the thus obtained dispersion (4 g) with stirring and the mixture was stirred at 50° C. for 12 h under nitrogen.

### Application Example 3

The compositions, obtained in Example 2, were coated and cured as described in Application Example 2. Chemical fastness and mechanical stability of the coatings was evaluated as described in Application Example 2. The results are summarized in Table 2.

TABLE 2

| | | 1-Methoxy-2- | Acetic | Mechanical |
|---|---|---|---|---|
| Dispersion type | Ethanol | propanol | Acid | Stability |
| Example 2 a) | 0 | 0 | 0 | 0 |
| Before UV curing | | | | |
| Example 2 a) | 4 | 4 | 4 | 1 |
| After UV curing | | | | |
| Example 2 b) | 0 | 0 | 0 | 0 |
| Before UV curing | | | | |
| Example 2 b) | 4 | 4 | 4 | 1 |
| After UV curing | | | | |
| Example 2 c) | 0 | 0 | 0 | 0 |
| Before UV curing | | | | |
| Example 2 c) | 4 | 4 | 4 | 1 |
| After UV curing | | | | |
| Example 2 d) | 0 | 0 | 0 | 0 |
| Before UV curing | | | | |
| Example 2 d) | 4 | 4 | 4 | 1 |
| After UV curing | | | | |

The present invention comprises the following embodiments:
1. A method for forming a coating having a high refractive index on a substrate comprising the steps of:
   a) providing a substrate, preferably carrying a surface relief nano- and/or microstructure;
   b) applying a coating composition to the substrate by means of wet coating, or printing;
   c) removing the solvent; and
   d) exposing the dry coating to actinic radiation, especially UV-light; or a method for forming a coating having a high refractive index on a substrate comprising the steps of
   a′) providing a sheet of base material, said sheet having an upper and lower surface;
   b) depositing a composition on at least a portion of the upper surface;
   c′) removing the solvent;
   d′) forming a surface relief micro- and/or nanostructure on at least a portion of the coating composition, such that said micro- and/or nanostructure is formed also in the base material, and
   e′) curing the coating composition by exposing it to actinic radiation, especially UV-light; or a method for forming a coating having a high refractive index on a substrate comprising the steps of
   a″) providing a sheet of base material, said sheet having an upper and lower surface;
   b″) depositing a coating composition on at least a portion of the upper surface;
   c″) removing the solvent;
   d″) curing the dry coating by exposing it to actinic radiation, especially UV-light; and
   e″) forming a surface relief micro- and/or nanostructure on at least a portion of the coating composition, such that said micro- and/or nanostructure is formed also in the base material; wherein
   the coating composition, comprising
   i) single or mixed metal oxide nanoparticles, wherein the volume average diameter (Dᵥ50) of the metal oxide nanoparticles is in the range of 1 to 20 nm; the nanoparticles comprise at least one volatile surface-modifying compound selected from alcohols, which are preferably selected from C₁-C₄alcohols; β-diketones, carboxylic acids and p-ketoesters and mixtures thereof, wherein the total amount of volatile surface-modifying compounds is at least 5% by weight, preferably at least 10% by weight based on the amount of metal oxide nanoparticles, and
   ii) a solvent.
   After exposing coating composition to actinic radiation, especially UV-light; the coating composition is cross-linked.
2. The method according to item (claim) 1, wherein the metal oxide nanoparticles are titanium dioxide nanoparticles.
3. The method according to item 1, or 2, wherein the volatile surface-modifying compound is selected from ethanol and acetylacetone and mixtures thereof.
4. The method according to any of item 1 to 3, wherein the volume average diameter (Dᵥ50) of the metal oxide nanoparticles is in the range of 1 to 10 nm, preferably 1 to 5 nm.
5. The method according to any of items 1 to 4, wherein the total amount of volatile surface-modifying compounds is in the range of from 15 to 50% by weight, especially from 20 to 40% by weight, very especially from 25 to 35% by weight based on the amount of metal oxide nanoparticles.
6. The method according to any of items 1 to 5, wherein the solvent is selected from C₂-C₄alcohols, especially ethanol, 1-propanol and isopropanol; ketones, especially acetone, 2-butanone, 2-pentanone, 3-pentanone, cyclopentanone and cyclohexanone; ether alcohols, especially 1-methoxy-2-propanol; mixtures thereof and their mixtures with esters, especially ethyl acetate, 1-propyl acetate, isopropyl acetate and butyl acetate.
7. The method according to any of items 1 to 6, wherein the single, or mixed metal oxide nanoparticles are obtained by a process comprising the following steps:
   a) preparing a mixture, comprising a metal alkoxide of formula Ti(OR¹²)₄ (Ia), metal halide of formula Ti(Hal)₄ (IIa), wherein R¹² and R^{12′} are independently of each other C₁-C₄alkyl, preferably methyl, ethyl, n-propyl, iso-propyl and n-butyl; Hal is Cl; a solvent, a tertiary alcohol and optionally water,
   b1) heating the mixture to a temperature of from 80° C. to 180° C.;
   b2) separating the obtained TiO₂ nanoparticles from the mixture;
   b3) resuspending the TiO₂ nanoparticles in an C₁-C₄alcohol, or a mixture of C₁-C₄alcohols;
   b4) optionally treating the TiO₂ nanoparticles with a β-diketone(s), or salts thereof, which are preferably selected from compounds of formula Me(OR²⁰)ₓ(L)_{y} (V), or mixtures thereof, wherein
   R²⁰ is a C₁-C₈ alkyl group, preferably, a C₁-C₄ alkyl group, such as, for example, methyl, ethyl, n-propyl, iso-propyl and n-butyl;
   L⁻ is a group of formula

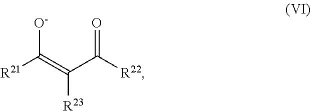

R²¹ and R²² are independently of each other a C₁-C₈alkyl group; a phenyl group, which may optionally be substituted by one or more C₁-C₄alkyl groups, or C₁-C₄alkoxy groups; a C₂-C₅heteroaryl group, which may optionally be substituted by one or more C₁-C₄alkyl groups, or C₁-C₄alkoxy groups; or a C₁-C₈alkoxy group, R²³ is a hydrogen atom, a fluorine atom, a chlorine atom, or a C₁-C₈alkyl group, or
   R²¹ and R²² together form a cyclic or bicyclic ring, which may optionally be substituted by one or more C₁-C₄alkyl groups;
   Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V), preferably Zn (II), Ti (IV), Zr (IV), Hf (IV), Sn (IV), Nb (V) and Ta (V), more preferably Ti (IV), Zr (IV), Sn (IV), Nb (V) and Ta (V),
   x is in the range from 0 to 4.9, preferably 0 to 4.5, y is in the range from 0.1 to 5, preferably 0.5 to 5, and the sum x+y equals to the oxidation state of metal;
   c1) treating the TiO₂ nanoparticles with a base;
   c2) optionally treating the TiO₂ nanoparticles with a β-diketone(s), or salt(s) thereof;
   c3) optionally treating the TiO₂ nanoparticles with a compound of formula Me′(OR^{20′})_{z} (VII), or mixtures thereof, wherein R^{20′} is a C₁-C₈alkyl group, preferably a C₁-C₄ alkyl group;
   Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V), preferably Ti (IV), Zr (IV), Sn (IV), Nb (V) and Ta (V); and
   z equals to the oxidation state of metal; wherein
   the ratio of moles of hydroxy groups of tertiary alcohol to total moles of Ti is in the range 1:2 to 6:1, preferably 1:2 to 4:1, most preferably 1:2 to 3.5:1;
   the base is selected from the group consisting of alkali metal alkoxides, especially potassium ethylate; alkali metal hydroxides, especially potassium hydroxide; alkali metal salts of carboxylic acids, especially potassium acrylate and methacrylate and combinations thereof,
   the solvent is selected from 2-methyltetrahydrofurane, tetrahydropyrane, 1,4-dioxane, cyclopentylmethyl ether, di-n-propyl ether, di-isobutyl ether, di-tert-butyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene gly-col) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof;
   the tertiary alcohol is selected from tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol), and wherein in step b1) the alcohol R¹²OH is removed by distillation.
8. The method according to any of items 1 to 7, comprising
   i) titanium dioxide nanoparticles, wherein the volume average diameter (Dᵥ50) of the titanium dioxide nanoparticles is in the range of 1 to 10 nm, especially 1 to 5 nm; the nanoparticles comprise at least one volatile surface-modifying compound selected from ethanol and acetylacetone and mixtures thereof, wherein the total amount of volatile surface-modifying compounds is in the range of from 15 to 50% by weight, especially from 20 to 40% by weight, very especially from 25 to 35% by weight based on the amount of metal oxide nanoparticles; and
   ii) a solvent which is selected from C₂-C₄alcohols, especially ethanol, 1-propanol and isopropanol; ketones, especially acetone, 2-butanone, 2-pentanone, 3-pentanone, cyclopentanone and cyclohexanone; ether alcohols, especially 1-methoxy-2-propanol; mixtures thereof and their mixtures with esters, especially ethyl acetate, 1-propyl acetate, isopropyl acetate and butyl acetate.
9. The method according to any of items 1 to 8, wherein the coating composition comprises less than 1% w/w of water.
10. The method according to any of items 1 to 9, wherein the coating composition does not comprise a binder.

Preferably, the coating composition does not comprise an organic radical photoinitiator.

The pH of the coating composition is in the range of 3 to 10, preferably 3 to 7.

Preferably, the titanium dioxide nanoparticles are present in the anatase modification.

Preferably, the volatile surface-modifying compound is selected from a C₁-C₄alcohols, such as, for example, ethanol, 1-propanol and isopropanol; β-diketones and mixtures thereof. More preferably, the volatile surface-modifying compound is selected from ethanol and acetylacetone and mixtures thereof.
11. The method according to any of items 1 to 10, comprising the steps of:
   a) forming a surface relief micro- and/or nanostructure on a discrete portion of the substrate;
   b) applying a coating composition on at least a portion of the surface relief micro- and/or nanostructure by means of wet coating, or printing;
   c) removing the solvent; and
   d) curing the dry coating by exposing it to actinic radiation, especially UV-light.
12. The method according to item 11, wherein step a) comprises
   a1) applying a curable compound to at least a portion of the substrate;
   a2) contacting at least a portion of the curable compound with surface relief micro- and nanostructure forming means; and
   a3) curing the curable compound.
13. A security, or decorative element, comprising a substrate, which may contain indicia or other visible features in or on its surface, and on at least part of the said substrate surface a coating obtained according to the method according to any of items 1 to 12.
14. A process for the preparation of a coating composition, comprising the following steps:
   a) preparing a mixture, comprising a metal oxide precursor compound(s), a solvent, a tertiary alcohol, or a secondary alcohol, wherein the tertiary alcohol and secondary alcohol eliminate water upon heating the mixture to a temperature of above 60° C., or mixtures, containing the tertiary alcohol(s) and/or the secondary alcohol(s), and optionally water,
   b1) heating the mixture to a temperature of above 60° C., especially to a temperature of from 80 to 180° C.;
   b2) separating the obtained metal oxide nanoparticles from the mixture;
   b3) resuspending the metal oxide nanoparticles in an alcohol, or a mixture of alcohols;
   b4) optionally treating the metal oxide nanoparticles with a volatile surface-modifying compound selected from β-diketones, carboxylic acids and p-ketoesters and mixtures thereof; or salts thereof, which are preferably selected from compounds of formula Me(OR²⁰)ₓ(L)_{y} (V), or mixtures thereof, wherein
   R²⁰ is a C₁-C₈ alkyl group, preferably, a C₁-C₄ alkyl group, such as, for example, methyl, ethyl, n-propyl, iso-propyl and n-butyl;

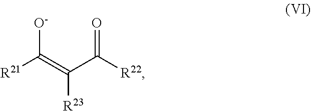

L⁻ is a group of formula
   R²¹ and R²² are independently of each other a C₁-C₈alkyl group; a phenyl group, which may optionally be substituted by one or more C₁-C₄alkyl groups, or C₁-C₄alkoxy groups; a C₂-C₅heteroaryl group, which may optionally be substituted by one or more C₁-C₄alkyl groups, or C₁-C₄alkoxy groups; or a C₁-C₈alkoxy group, R²³ is a hydrogen atom, a fluorine atom, a chlorine atom, or a C₁-C₈alkyl group, or
   R²¹ and R²² together form a cyclic or bicyclic ring, which may optionally be substituted by one or more C₁-C₄alkyl groups;
   Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V), preferably Zn (II), Ti (IV), Zr (IV), Hf (IV), Sn (IV), Nb (V) and Ta (V), more preferably Ti (IV), Zr (IV), Sn (IV), Nb (V) and Ta (V),
   x is in the range from 0 to 4.9, preferably 0 to 4.5, y is in the range from 0.1 to 5, preferably 0.5 to 5, and the sum x+y equals to the oxidation state of metal;
   c1) treating the metal oxide nanoparticles with a base, especially a base which is selected from the group consisting of alkali metal alkoxides, alkali metal hydroxides, alkali metal salts of carboxylic acids, tetraalkylammonium hydroxides, trialkylbenzylammonium hydroxides and combinations thereof,
   c2) optionally treating the metal oxide nanoparticles with the volatile surface-modifying compound, or salts thereof; and
   c3) optionally treating the TiO₂ nanoparticles with a compound of formula
   Me′(OR^{20′})_{z} (VII), or mixtures thereof, wherein
   R^{20′} is a C₁-C₈alkyl group, preferably a C₁-C₄ alkyl group;
   Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V), preferably Ti (IV), Zr (IV), Sn (IV), Nb (V) and Ta (V); and
   z equals to the oxidation state of metal; wherein
   the metal oxide precursor compound(s) is selected from the group consisting of
   metal alkoxides of formula Me(OR¹²)ₓ (I), metal halides of formula Me′(Hal)_{x′} (II) and
   metal alkoxyhalides of formula Me″(Hal′)ₘ(OR^{12′})ₙ (III) and mixtures thereof, wherein
   Me, Me′ and Me″ are independently of each other titanium, tin, tantalum, niobium, hafnium, or zirconium;
   x represents the valence of the metal and is either 4 or 5,
   x′ represents the valence of the metal and is either 4 or 5;
   R¹² and R^{12′} are independently of each other a C₁-C₈alkyl group;
   Hal and Hal′ are independently of each other Cl, Br or I;
   m is an integer of 1 to 4;
   n is an integer of 1 to 4;
   m+n represents the valence of the metal and is either 4 or 5;
   the solvent comprises at least one ether group and is different from the tertiary alcohol and the secondary alcohol;
   the ratio of the sum of moles of hydroxy groups of tertiary alcohol(s) and secondary alcohol(s) to total moles of Me, Me′ and Me″ is in the range 1:2 to 6:1.

1.-15. (canceled)

16. A coating composition, comprising
i) single or mixed metal oxide nanoparticles, wherein the volume average diameter (Dᵥ50) of the metal oxide nanoparticles is in the range of 1 to 20 nm; the nanoparticles comprise at least one volatile surface-modifying compound selected from alcohols; β-diketones, or salts thereof; carboxylic acids and p-ketoesters and mixtures thereof, wherein the total amount of volatile surface-modifying compounds is at least 5% by weight, based on the amount of metal oxide nanoparticles, and
ii) a solvent; with the proviso that
the coating composition comprises less than 1% w/w of water and does not comprise a binder.

17. The coating composition according to claim 16, wherein the metal oxide nanoparticles are titanium dioxide nanoparticles.

18. The coating composition according to claim 16, wherein the volatile surface-modifying compound is selected from ethanol and acetylacetone and mixtures thereof.

19. The coating composition according to claim 16, wherein the volume average diameter (Dᵥ50) of the metal oxide nanoparticles is in the range of 1 to 10 nm.

20. The coating composition according to claim 16, wherein the total amount of volatile surface-modifying compounds is in the range of from 15 to 50% by weight based on the amount of metal oxide nanoparticles.

21. The coating composition according to claim 16, wherein the solvent is selected from C₂-C₄ alcohols.

22. The coating composition according to claim 16, wherein the single, or mixed metal oxide nanoparticles are obtained by a process comprising the following steps:
a) preparing a mixture, comprising a metal alkoxide of formula Ti(OR¹²)₄, metal halide of formula Ti(Hal)₄, wherein R¹² is C₁-C₄alkyl;
Hal is Cl; a solvent, a tertiary alcohol and optionally water,
b1) heating the mixture to a temperature of from 80° C. to 180° C.;
b2) separating the obtained TiO₂ nanoparticles from the mixture;
b3) resuspending the TiO₂ nanoparticles in an C₁-C₄alcohol, or a mixture of C₁-C₄alcohols;
b4) optionally treating the TiO₂ nanoparticles with a β-diketone(s), or salts thereof, which are selected from compounds of formula Me(OR²⁰)ₓ(L)_{y}, or mixtures thereof, wherein R²⁰ is a C₁-C₈ alkyl group; 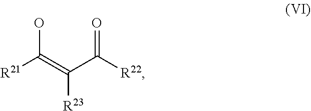
L is a group of formula R (VI),
R²¹ and R²² are independently of each other a C₁-C₈ alkyl group; a phenyl group, which may optionally be substituted by one or more C₁-C₄ alkyl groups, or C₁-C₄ alkoxy groups; a C₂-C₅ heteroaryl group, which may optionally be substituted by one or more C₁-C₄ alkyl groups, or C₁-C₄ alkoxy groups; or a C₁-C₈ alkoxy group,
R²³ is a hydrogen atom, a fluorine atom, a chlorine atom, or a C₁-C₈ alkyl group, or
R²¹ and R²² together form a cyclic or bicyclic ring, which may optionally be substituted by one or more C₁-C₄ alkyl groups;
Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V),
x is in the range from 0 to 4.9, y is in the range from 0.1 to 5, and the sum x+y equals to the oxidation state of metal;
c1) treating the TiO₂ nanoparticles with a base;
c2) optionally treating the TiO₂ nanoparticles with a β-diketone(s), or salt(s) thereof,
c3) optionally treating the TiO₂ nanoparticles with a compound of formula Me′(OR^{20′})_{z}, or mixtures thereof, wherein
R^{20′} is a C₁-C₈ alkyl group;
Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V); and
z equals to the oxidation state of metal; wherein
the ratio of moles of hydroxy groups of tertiary alcohol to total moles of Ti is in the range 1:2 to 6:1;
the base is selected from the group consisting of alkali metal alkoxides, the solvent is selected from 2-methyltetrahydrofurane, tetrahydropyrane, 1,4-dioxane, cyclopentylmethyl ether, di-n-propyl ether, di-isobutyl ether, di-tertbutyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene gly-col) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof;
the tertiary alcohol is selected from tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol), and wherein in step b1) the alcohol R¹²OH is removed by distillation.

23. The coating composition according to claim 16, comprising
i) titanium dioxide nanoparticles, wherein the volume average diameter (Dᵥ50) of the titanium dioxide nanoparticles is in the range of 1 to 10 nm; the nanoparticles comprise at least one volatile surface-modifying compound selected from ethanol and acetylacetone and mixtures thereof, wherein the total amount of volatile surface-modifying compounds is in the range of from 15 to 50% by weight based on the amount of metal oxide nanoparticles; and
ii) a solvent which is selected from C₂-C₄ alcohols.

24. A coating having a refractive index of greater than 1.7, obtained from the coating composition according to claim 16.

25. A method for forming a coating having a high refractive index on a substrate comprising the steps of:
a) providing a substrate;
b) applying the coating composition according to claim 16 to the substrate by means of wet coating, or printing;
c) removing the solvent; and
d) exposing the dry coating to actinic radiation.

26. A security, or decorative element, comprising a substrate, which may contain indicia or other visible features in or on its surface, and on at least part of the said substrate surface, a coating according to claim 24.

27. A method for forming a surface relief micro- and nanostructure on a substrate comprising the steps of:
a) forming a surface relief micro- and/or nanostructure on a discrete portion of the substrate;
b) depositing the coating composition according to claim 16 on at least a portion of the surface relief micro- and/or nanostructure;
c) removing the solvent; and
d) curing the dry coating by exposing it to actinic radiation; or
a method for forming a surface relief micro- and/or nanostructure on a substrate comprising the steps of
a′) providing a sheet of base material, said sheet having an upper and lower surface;
b′) depositing the coating composition according to claim 16 on at least a portion of the upper surface;
c′) removing the solvent;
d′) forming a surface relief micro- and/or nanostructure on at least a portion of the coating composition, such that said micro- and/or nanostructure is formed also in the base material, and
e′) curing the coating composition by exposing it to actinic radiation;
or a method for forming a surface relief micro- and/or nanostructure on a substrate comprising the steps of
a″) providing a sheet of base material, said sheet having an upper and lower surface;
b″) depositing the coating composition according to claim 16 on at least a portion of the upper surface;
c″) removing the solvent;
d″) curing the dry coating by exposing it to actinic radiation; and
e″) forming a surface relief micro- and/or nanostructure on at least a portion of the coating composition, such that said micro- and/or nanostructure is formed also in the base material.

28. The method according to claim 27, wherein step a) comprises
a1) applying a curable compound to at least a portion of the substrate;
a2) contacting at least a portion of the curable compound with surface relief micro- and nanostructure forming means; and
a3) curing the curable compound.

29. A method comprising providing the coating composition according to claim 16 and coating diffractive optical elements (DOEs), holograms, manufacturing of optical waveguides and solar panels, light outcoupling layers for display and lighting devices, high dielectric constant (high-k) gate oxides and interlayer high-k dielectrics, anti-reflection coatings, etch and CMP stop layers, optical thin film filters, optical diffractive gratings and hybrid thin film diffractive grating structures, high refractive index abrasion-resistant coatings, in protection and sealing (OLED), or organic solar cells.

30. A process for the preparation of the composition according to claim 16, comprising the following steps:
a) preparing a mixture, comprising a metal oxide precursor compound(s), a solvent, a tertiary alcohol, or a secondary alcohol, wherein the tertiary alcohol and secondary alcohol eliminate water upon heating the mixture to a temperature of above 60° C., or mixtures, containing the tertiary alcohol(s) and/or the secondary alcohol(s), and optionally water,
b1) heating the mixture to a temperature of above 60° C.;
b2) separating the obtained metal oxide nanoparticles from the mixture;
b3) resuspending the metal oxide nanoparticles in an alcohol, or a mixture of alcohols;
b4) optionally treating the metal oxide nanoparticles with a volatile surface-modifying compound selected from β-diketones, carboxylic acids and p-ketoesters and mixtures thereof; or salts thereof, which are selected from compounds of formula Me(OR²⁰)ₓ(L)_{y}, or mixtures thereof, wherein
R²⁰ is a C₁-C₈ alkyl group; 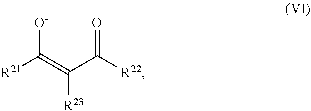
L⁻ is a group of formula R (VI),
R²¹ and R²² are independently of each other a C₁-C₈alkyl group; a phenyl group, which may optionally be substituted by one or more C₁-C₄alkyl groups, or C₁-C₄alkoxy groups; a C₂-C₅heteroaryl group, which may optionally be substituted by one or more C₁-C₄alkyl groups, or C₁-C₄alkoxy groups; or a C₁-C₈alkoxy group,
R²³ is a hydrogen atom, a fluorine atom, a chlorine atom, or a C₁-C₈alkyl group, or
R²¹ and R²² together form a cyclic or bicyclic ring, which may optionally be substituted by one or more C₁-C₄alkyl groups;
Me is selected from alkali and alkali earth metals, Zn (II), In (III), Sc (III), Y (III), La (III), Ce (IV), Ti (III), Ti (IV), Zr (IV), Hf (IV), Sn (IV), V (IV), Nb (V), Ta (V),
x is in the range from 0 to 4.9, y is in the range from 0.1 to 5, and the sum x+y equals to the oxidation state of metal;
c1) treating the metal oxide nanoparticles with a base,
c2) optionally treating the metal oxide nanoparticles with the volatile surface-modifying compound, or salts thereof, and
c3) optionally treating the TiO₂ nanoparticles with a compound of formula Me′(OR^{20′})_{z}, or mixtures thereof, wherein
R^{20′} is a C₁-C₈ alkyl group;
Me′ is selected from Zn (II), In (III), Sc (III), Y (III), La (III), Ce (IV), Ti (III), Ti (IV), Zr (IV), Hf (IV), Sn (IV), V (IV), Nb (V) and Ta (V); and
z equals to the oxidation state of metal; wherein
the metal oxide precursor compound(s) is selected from the group consisting of metal alkoxides of formula Me(OR¹²)ₓ, metal halides of formula Me′(Hal)_{x′} and
metal alkoxyhalides of formula Me″(Hal′)ₘ(OR^{12′})ₙ and mixtures thereof, wherein
Me, Me′ and Me″ are independently of each other titanium, tin, tantalum, niobium, hafnium, or zirconium;
x represents the valence of the metal and is either 4 or 5,
x′ represents the valence of the metal and is either 4 or 5;
R¹² and R^{12′} are independently of each other a C₁-C₈ alkyl group;
Hal and Hal′ are independently of each other Cl, Br or I;
m is an integer of 1 to 4;
n is an integer of 1 to 4;
m+n represents the valence of the metal and is either 4 or 5;
the solvent comprises at least one ether group and is different from the tertiary alcohol and the secondary alcohol;
the ratio of the sum of moles of hydroxy groups of tertiary alcohol(s) and secondary alcohol(s) to total moles of Me, Me′ and Me″ is in the range 1:2 to 6:1.
